(19) United States
(12) Patent Application Publication
(10) Pub. No.: US 2025/0326245 A1
(43) Pub. Date: Oct. 23, 2025

(54) MAGNETICALLY CONNECTABLE SPINNER DEVICE AND METHOD FOR MAKING THE DEVICE

(71) Applicants: Adam MAZZOCHI, Manorville, NY (US); Sophia MAZZOCHI, Manorville, NY (US)

(72) Inventors: Adam MAZZOCHI, Manorville, NY (US); Sophia MAZZOCHI, Manorville, NY (US)

(21) Appl. No.: 19/182,241

(22) Filed: Apr. 17, 2025

Related U.S. Application Data
(60) Provisional application No. 63/635,066, filed on Apr. 17, 2024.
(60) Provisional application No. 63/635,803, filed on Apr. 18, 2024.
(60) Provisional application No. 63/657,978, filed on Jun. 10, 2024.
(60) Provisional application No. 63/671,737, filed on Jul. 15, 2024.
(60) Provisional application No. 63/688,295, filed on Aug. 28, 2024.
(60) Provisional application No. 63/691,260, filed on Sep. 5, 2024.
(60) Provisional application No. 63/700,758, filed on Sep. 30, 2024.

(51) Int. Cl. B43K 29/00; B43K 25/00; F21V 33/00

(52) U.S. Cl. CPC B43K 29/003; B43K 25/00; B43K 29/005; F21V 33/0048

(57) ABSTRACT

There is disclosed a device having a magnetic connection comprising a first body section, a second body section; at least one first magnet coupled to the first body section and at least one second magnet coupled to the second body section. The first magnet is polarized to have a first magnetic field; and the second magnet is polarized to have a second magnetic field that is configured to attract the first magnet. The first magnet and the second magnet have a circular or a polygonal cross-section and the magnetic fields are configured so as to keep the magnets in contact the first magnet is rotating around the second magnet. There is also a method for manufacturing the device which includes determining the lengths and weights of the two body sections, determining the strength of the two magnets and the geometry of the two magnets connecting the two bodies together.

### CROSS REFERENCE TO RELATED APPLICATIONS

This application is a non-provisional application which hereby claims priority to provisional applications 63/635,066 filed on Apr. 17, 2024, 63/635,803 filed on Apr. 18, 2024, 63/657,978 filed on Jun. 10, 2024, 63/671,737 filed on Jul. 15, 2024, 63/688,295 filed on Aug. 28, 2024, 63/691,260 filed on Sep. 5, 2024, and 63/700,758 filed on Sep. 30, 2024 the disclosures of these applications hereby incorporated herein by reference in their entirety.

### BACKGROUND OF THE INVENTION

At least one embodiment relates to a magnetically connectable spinner device. There is also at least one additional embodiment wherein there is a method for manufacturing the magnetically connectable and/or spinning device. In at least one embodiment, there is a first component which is a pencil and a second component that is an eraser, each of the pencil and the eraser are connectable via magnets which are configured to connect both directly and/or at an angle to allow for one component to spin around another component when activated by a user. While a pencil is indicated as being one set of components, other components can be used such as two separate parts of a pen, or alternatively two parts of an oblong shaped article or any other suitable article which is configured to allow the first article to spin around the second article. Thus, there is a need for a way to connect two objects together which allows one object to spin around the other object while providing enjoyment for the user as well as stress relief when used as a fidget toy.

### SUMMARY

There is a device that has a magnetic connection comprising a first body section, a second body section, at least one first magnet coupled to the first body section and at least one second magnet coupled to the second body section. The first magnet is polarized to have a first magnetic field; and the second magnet is polarized to have a second magnetic field that is configured to attract the first magnet. In one embodiment the first magnet and the second magnet have a circular cross-section, and the magnetic fields are configured so as to keep the magnets in contact when the first magnet is rotating around the second magnet.

There is a disclosed a separate device that can be used to levitate the embodiment. There can be a stand which has a magnetic element having a curved element which can be in the form of a semi-circle. This magnetic element can be in the form of one or more magnets.

One stand has at least two simple magnets placed under the magnets of the writing implement with opposing polarity. Each stand has a set distance to hold the point of the larger body section in order for the embodiment to levitate. There is a separate stand with abrasion on the floor of the stand to hold the pencil embodiment in place to allow it to levitate as it gets smaller by sharpening being held in place by the abrasion. Examples of abrasion could be a rough surface, or it could also be finer abrasion like sandpaper. The goal of the two magnets that will levitate our embodiments is to stow them away into different products that are common in many different markets. The idea of hiding these magnets is to show our embodiment levitating over different products. Some examples to hide these magnets can be hidden into figurines, or into the eyes of a butterfly or on the ends of a football goal post, or anything else that can be created with the creative imagination that will in the end show our embodiment levitating over it.

The goal of this levitation stand, in conjunction with the fidget spinning aspects of this invention, is to make life more interesting to the user. Fidget toys have many benefits besides its coolness factor which includes stress relief and mindfulness. Fidget toys are known to help with focus and clarity. At least one embodiment also upgrades standard writing equipment to make it more interesting. The standard pencil was created in the 16th century and hasn't changed much since.

While the magnets can have an edge that is substantially square, in at least one embodiment the edge of at least one magnet can be a beveled edge. In another embodiment, the edge can be a rounded edge. In addition, at least one of the magnets can be substantially conical in shape. In another embodiment, the body section and/or the edge section can have any one of a surface such as stippling, indents, protrusion, and/or grooves. In at least one embodiment, the device can include a connector which connects the first body section to the second body section. The connector can be at least one of a string, an elastic string, a line, a rope, an elastic band, or cable or anything clastic. In at least one embodiment the string is an elastic string which stretches to allow for movement of the two different bodies to separate and then rotate around each other. In at least one embodiment, there can be a rotatable connector wherein the connector is connected at the first end to the rotatable connector and to a second end to at least one body section. The rotatable connector is coupled to the other body section. The rotatable connector can be in the form of a rotating cylinder which rotates inside of a cylinder and rotates around via bearings.

In at least one embodiment, the first body section comprises a pencil and the second body section comprises an eraser section of the pencil. In at least one embodiment, the first body section comprises a pen and the second body section comprises an additional section of a pen, wherein at least one body section comprises a writable end.

There is also a method for manufacturing the device which includes determining the lengths and weights of the two body sections, determining the strength of the two magnets and the geometry of the two magnets and connecting the two bodies together. In at least one embodiment, the method can include selecting a surface on the magnet such as any one of a surface such as stippling, indents, protrusion, and/or grooves. These surfaces can also be made on a separate cover that covers and protects the magnet. In at least one embodiment, the process can include selecting a first magnet and a second magnet such that the first magnet and the second magnet have a sufficient magnetic force so that when the first body section intersects the second body section at a substantially right angle, the first magnet remains in contact with the second magnet via the magnetic force between the magnets. This magnetic force is selected to keep the magnets in contact with each other even when the first body section is spinning around the second body section.

There is also disclosed a separate device where the magnets are installed into a ferrule of a pencil and when coupled together it looks just like a standard pencil. The ferrule can be split in the middle or split closer to the larger embodiment giving the eraser portion of the ferrule more mass to hold on to and spin the larger embodiment. The ferrule can where its coupled together be closed completely covering the magnet or it can be open showing the face of the magnets. One portion of the ferrule is installed over a magnet on to the larger writing portion of the pencil, the other portion of the ferrule will hold the other magnet and the eraser allowing the user to hold the smaller eraser portion of the ferrule to either fidget the eraser portion or spin the larger embodiment of the pencil holding the smaller embodiment. In another embodiment the pen or pencil is split more towards a middle section of a pen or pencil body. This provides a more even distribution or ratio between the sizes of the first body section and the second body section. For example, the ratio of the size distributions between the body sections can be 1:1, 1:2, 1:3, 1:4, 1:5, 1:6 or any other suitable size distribution between the two body sections.

The magnets are either installed inside the body sections by itself or with a separate cover to go over the magnet and compress or screw on to the embodiment holding the magnet in place and protecting the magnet. The magnets can be directly installed on to the body sections. These magnets can have sufficient coatings to protect the magnet so that it can be installed directly to the body section by any means of fastening.

Thus, there is a device and a method which allows a user to occupy his or her hands with a device that allows one body section to spin around another body section.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is a perspective view of the device in full contact;

FIG. 1B is a side view of the embodiment of FIG. 1A;

FIG. 1C is a side view of another embodiment;

FIG. 2A is a side view of the device wherein the two body sections are aligned at a substantially right angle;

FIG. 2B is a side view of another embodiment;

FIG. 2C is a view of an open end of a clamp;

FIG. 2D is a view of another embodiment of a clamp;

FIG. 2E is a view of another embodiment of a clamp;

FIG. 3A is a side view of the embodiment of FIG. 1C;;

FIG. 3B is a perspective view of the embodiment of FIG. 1C;

FIG. 3C is a top view of another embodiment of the at least one magnet;

FIG. 4A is a perspective view of one magnet;

FIG. 4B is a top view of the magnet showing the potential rotational movement of one magnet vs. the other;

FIG. 5A is a side view of another embodiment of the at least one magnet;

FIG. 5B is a side perspective view of another embodiment;

FIG. 5C is a side view of another embodiment of the at least one magnet;

FIG. 5D is a top view of the embodiment of FIG. 5C;

FIG. 5E is a side view of another embodiment of at least one magnet;

FIG. 5F is a side view of another embodiment of at least one magnet;

FIG. 5G is another embodiment of at least one magnet;

FIG. 5H is another embodiment of at least one magnet;

FIG. 5I is a top view of another embodiment of at least one magnet;

FIG. 5J is a side view of another embodiment of a magnet;

FIG. 5K is a side view of another embodiment of a magnet;

FIG. 6A is a side view of at least one embodiment wherein the device is in contact at a right angle;

FIG. 6B is a side view of the device of the two body sections at a substantially right angle;

FIG. 6C is a side view of the two different body sections in a position offset from a right angle;

FIG. 7A is a view of another embodiment with three magnets;

FIG. 7B is a view of another embodiment with a connector element;

FIG. 8A is a side view of the device showing a first fastener for the magnet;

FIG. 8B is a side view of the device showing another fastener for the magnet;

FIG. 9A is a view of another embodiment;

FIG. 9B is a view of another embodiment;

FIG. 9C is a view of a fastening interface for a screw of FIG. 9B;

FIG. 9D is another view of another fastening interface;

FIG. 9E is another view of another fastening interface;

FIG. 10A shows a side view of a ferrule with a magnet disposed inside;

FIG. 10B shows an end view of a ferrule of FIG. 10A;

FIG. 10C is a perspective view of a ferrule of FIG. 10A;

FIG. 10D is a side view of the ferrule of FIG. 10A with a different magnet;

FIG. 11A is a perspective view of another ferrule;

FIG. 11B is an end view of the ferrule of FIG. 11A;

FIG. 11C is a side view of the ferrule of FIG. 11A with a magnet;

FIG. 11D is a perspective view of the ferrule of FIG. 11A;

FIG. 11E is a side view of the ferrule of FIG. 11A;

FIG. 11F is a side view of another embodiment;

FIG. 12A is a side view of two ferrules of FIGS. 10A and 11A put together;

FIG. 12B is a side view of the two ferrules;

FIG. 13A is a side view of another embodiment;

FIG. 13B is a side view of another embodiment;

FIG. 14A is a side view of another embodiment;

FIG. 14B is a side perspective view of another embodiment;

FIG. 14C is a side view of the embodiment of FIG. 14B;

FIG. 15A is a side view of another embodiment;

FIG. 15B is a side view of another embodiment;

FIG. 15C is a side view of an embodiment with a pen;

FIG. 15D is a side view of an embodiment with a pen and a clip and a cap;

FIG. 15E is a side view of the magnets for use with the embodiments of FIGS. 1A-15D;

FIG. 15F is another view of another embodiment for connecting to an adjacent body;

FIG. 16A is a perspective view of another embodiment;

FIG. 16B is a side view of the embodiment of FIG. 16A;

FIG. 16C is another perspective view of the embodiment of FIG. 16A;

FIG. 17A is a perspective view of another embodiment of a ferrule for use with a magnet;

FIG. 17B is a side view of the embodiment of FIG. 17A;

FIG. 17C is another perspective view of the embodiment of FIG. 17A;

FIG. 18A is a perspective view of another embodiment;

FIG. 18B is an opposite perspective view of the embodiment of FIG. 18A;

FIG. 18C is a side view of the embodiment of FIG. 18A;

FIG. 18D is a top view of another embodiment;

FIG. 18E is a side view of the embodiment of FIG. 18D;

FIG. 19A shows a side perspective view of another embodiment;

FIG. 19B is a side view of the embodiment of FIG. 19A.

FIG. 19C is a top-side perspective view of the embodiment of FIG. 19A;

FIG. 19D is a perspective view of another embodiment;

FIG. 20A is a side view of another embodiment;

FIG. 20B is a side perspective view of the embodiment of FIG. 20A;

FIG. 20C is a side perspective view of the embodiment of FIG. 20A;

FIG. 21A shows a side perspective view of another embodiment;

FIG. 21B is a side view of the embodiment of FIG. 21A;

FIG. 21C is a side perspective view of the embodiment of FIG. 21A;

FIG. 21D is a side view of a ferrule configured to receive a magnet and an eraser;

FIG. 21E is a side perspective view of the embodiment of FIG. 21A;

FIG. 22A is a side view of another embodiment which shows a split ferrule which has magnets embedded in each ferrule;

FIG. 22B is a side view of another embodiment which shows a split ferrule.

FIG. 22C is a view of an array of shapes for a magnet or cover;

FIG. 23A is a side bottom perspective view of another embodiment;

FIG. 23B is a side view of another embodiment;

FIG. 23C is a top side perspective view of the embodiment of FIG. 23A;

FIG. 24A is a side view of another embodiment;

FIG. 24B is a side cross-sectional view of the embodiment of FIG. 24A;

FIG. 24C is a side-top perspective view of the embodiment of FIG. 24A;

FIG. 24D is a side bottom perspective view of the embodiment of FIG. 24A;

FIG. 24E is an end view of a magnet for insertion into a ferrule;

FIG. 24F is a side cut away view of two separate caps and magnets coupled together with an elastic band;

FIG. 25A is a side view of the embodiment of FIG. 24A;

FIG. 25B is a side cross-sectional view of the embodiment of FIG. 24A;

FIG. 26A is a side exploded view of another embodiment;

FIG. 26B is a side top perspective exploded view of the embodiment of FIG. 26A;

FIG. 27A is a side bottom perspective view of another embodiment;

FIG. 27B is a side view of the embodiment of FIG. 27A;

FIG. 27C is a side view of the embodiment of FIG. 27A;

FIG. 28A is a front view of a stand;

FIG. 28B is a side view of a stand;

FIG. 28C is a bottom view of a stand;

FIG. 29A is a bottom-side perspective view of a stand with an instrument;

FIG. 29B is a side perspective view of the stand shown in FIG. 29A;

FIG. 29C is a side view of the stand of FIG. 29A;

FIG. 29D is a top side perspective view of the stand of FIG. 29A;

FIG. 30A is a bottom side perspective view of another embodiment;

FIG. 30B is a side view of the embodiment of FIG. 30A;

FIG. 31A is a front view of another embodiment;

FIG. 31B is a front view of another embodiment;

FIG. 31C is a front view of another embodiment;

FIG. 31D is a front view of another embodiment;

FIG. 31E is a perspective view of another embodiment;

FIG. 31F is a front view of another embodiment;

FIG. 31G is a front view of another embodiment;

FIG. 32 is a view of a flow chart for the process for making the device;

FIG. 33 is a flow chart selecting the magnet; and

FIG. 34 is a flow chart for the process for producing the stand.

### DETAILED DESCRIPTION

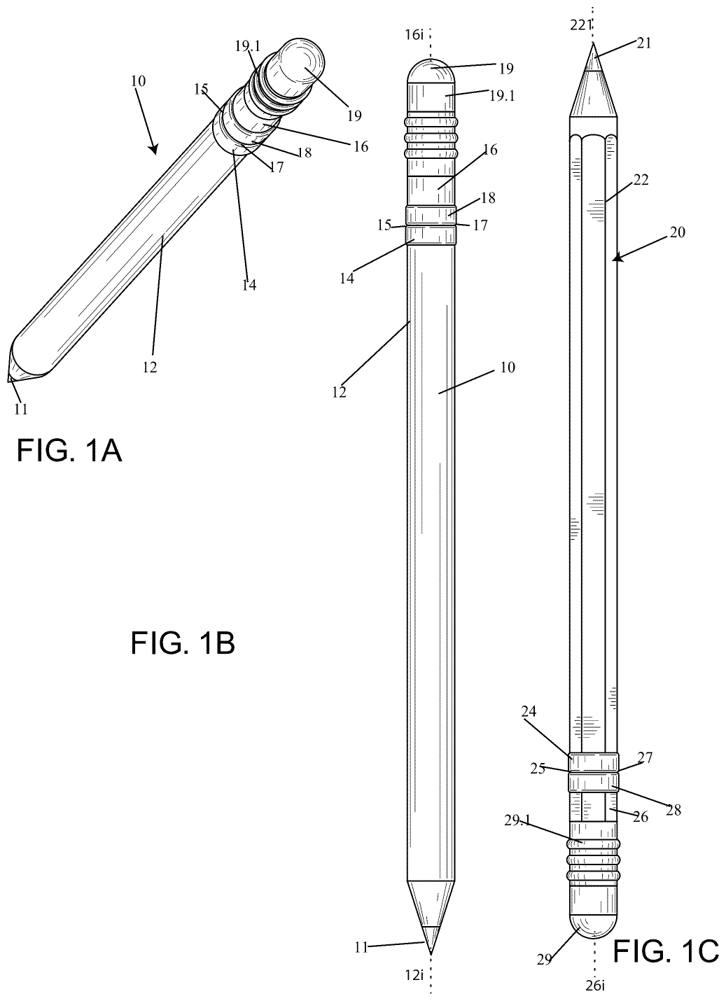

FIG. 1A is a bottom perspective view of a first embodiment of a device 10 which includes a first body section 12, and a second body section 16. First body section 12 has a writable tip 11 as well as a magnet 14 coupled at an opposite end of the first body section 12. Coupled to the second body section 16 is a magnet 18. There is clamp 19.1 which clamps an eraser 19 to the second body section 16. In at least one embodiment, the eraser is removable from the clamp 19.1.

FIG. 1B is a side view of the embodiment of FIG. 1A. In this view there is device 10 which includes first body section 12, as well as a second body section 16. There is also shown first magnet 14 as well as second magnet 18. Magnet 14 has a beveled section or edge 15 while second magnet 18 has a beveled section or edge 17. The beveled edge sections 15 and 17 can be in the form of an angled section and/or a rounded section. Alternatively, the edge section can be a square section as well. There is also clamp or ferrule 19.1 which has an eraser 19 coupled to the clamp at one end and to the second body section 16 at the other end.

FIG. 1C shows another embodiment 20 which is also a pencil. This pencil rather than being round has sides, wherein the cross-sectional shape of the pencil can be either hexagonal or octagonal square, triangle, rectangle or square. This pencil has a first body section 22 having a pencil tip 21 which is a writable end. The first body section 22 extends from the writable end to the connection with the magnet 24. The magnet 24 can have any shape, but in this embodiment has a beveled edge 25. There is a second body section 26 which is coupled to magnet 28 wherein magnet 28 has a beveled edge 27. There is a clamp 29.1 or ferrule which is secured at a first end to second body section 26, and which holds an eraser 29 in the opposite end. For the embodiments of FIG. 1A, 1B and IC the lengths of the first body sections are longer than the lengths of the second body sections as taken along their longitudinal axis 16i or 22i.

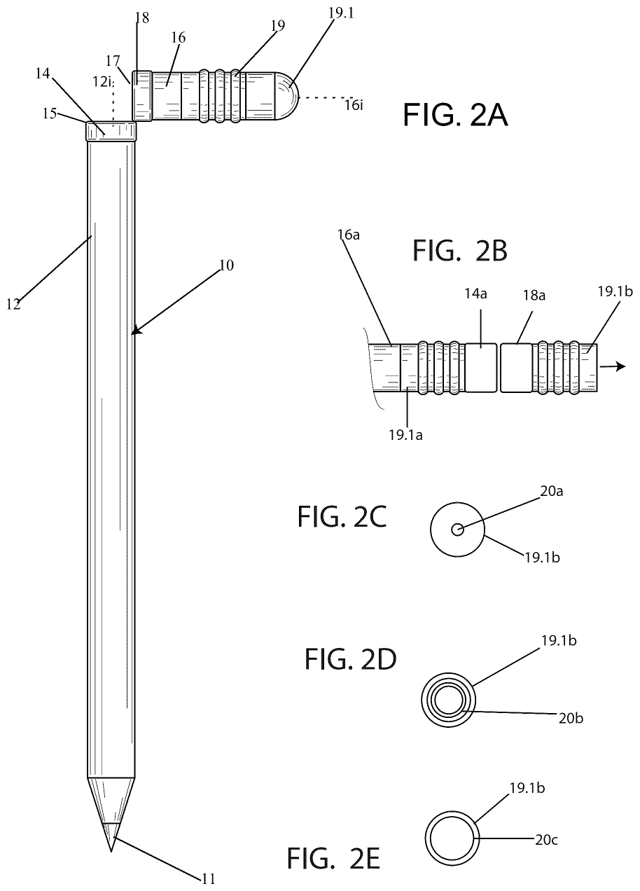

FIG. 2A shows a side view of the first embodiment wherein the first body section 12 is shown extending along its longitudinal axis 12i while the second body section is shown extending along its longitudinal axis 16i wherein the longitudinal axis 12i extends substantially perpendicular or substantially at a right angle to the longitudinal axis 16i Therefore the first body section 12 intersects the second body section at a substantially right angle or at substantially perpendicular to each other. This means that the first magnet 14 intersects the second magnet 18 substantially perpendicular to each other. The longitudinal extension of the first magnet 14 is coaxial to the longitudinal axis 12i, while the longitudinal extension of the second magnet is coaxial to the longitudinal axis 16i. While the term longitudinal extension of the magnets 14 and 18 is used here, the longitudinal extension of each of these magnets may be shorter than the diameter of each of these magnets as well as each of the magnets may be formed as a substantially cylindrical disc. The term substantially with respect to perpendicular or right angle can mean exactly a right angle or perpendicular or even offset from a right angle by any amount up to a 45-degree intersection of the longitudinal axis 12i with the longitudinal axis 16i. This means that the intersection of the two bodies 12 and 16, or 22 and 26 as well as their corresponding magnets 14 and 18 or 24 and 28 or corresponding longitudinal axes 12i, 22i or 16i or 18i can be for example at 90 degrees, 85 degrees, 80 degrees, 75 degrees, 70 degrees, 65 degrees 60 degrees, 55 degrees 50 degrees or even 45 degrees or any angle in between 45-90 when the user is actively spinning the first body 12 or 22 around the second body 16 and 26. Alternatively, the term substantially with respect to the shape of the magnets can mean entirely or deviating from the standard shape approximately 5%, 10%, 15% or 20% from the shape of the design. For example, if the shape is substantially conical it can be either entirely conical or conical with a 5% deviation, a 10% shape deviation, a 15% shape deviation or a 20% shape deviation. If the body section(s) are substantially cylindrical they can also have the cross section of a circle, a hexagon, an octagon, a decagon or any other suitable cross-sectional shape that still provides a substantially cylindrical shape.

FIG. 2B shows another view of clamps or ferrules 19.la and 19.1b coupled to magnets such as magnets 14a and 18a respectively so that this device can form an adapter that can be coupled to any adjacent oblong object. For example, in one embodiment clamp 19.1a is coupled to an adjacent oblong object 16a at one end and coupled to magnet 14a at the opposite end. In addition, clamp or ferrule 19.1b is open and capable of coupling to another oblong object at its open end and coupled to magnet 18a at the opposite end. The open ends of these clamps are configured to receive oblong objects and clamp to them. In one embodiment, the open ends are threaded, and the oblong objects can be screwed into them. In another embodiment, the open ends can have a spike, and the oblong objects can be forced onto them. Other forms of fastening can also be used such as through flexible rubber gaskets or other friction fit type receptacles.

FIG. 2C shows one embodiment of an open end to receive an oblong object comprising a spike 20a which is positioned in a center region of the ferrule 19.1b.

FIG. 2D is another embodiment of the open end of clamp 19.1b which shows threads 20b configured to receive the oblong object such as object 16a.

FIG. 2E is another embodiment of the open end of clamp 19.1b which shows gasket 20c positioned inside of clamp 19.1b and configured to receive an oblong object such as object 16a and secure it via friction fit.

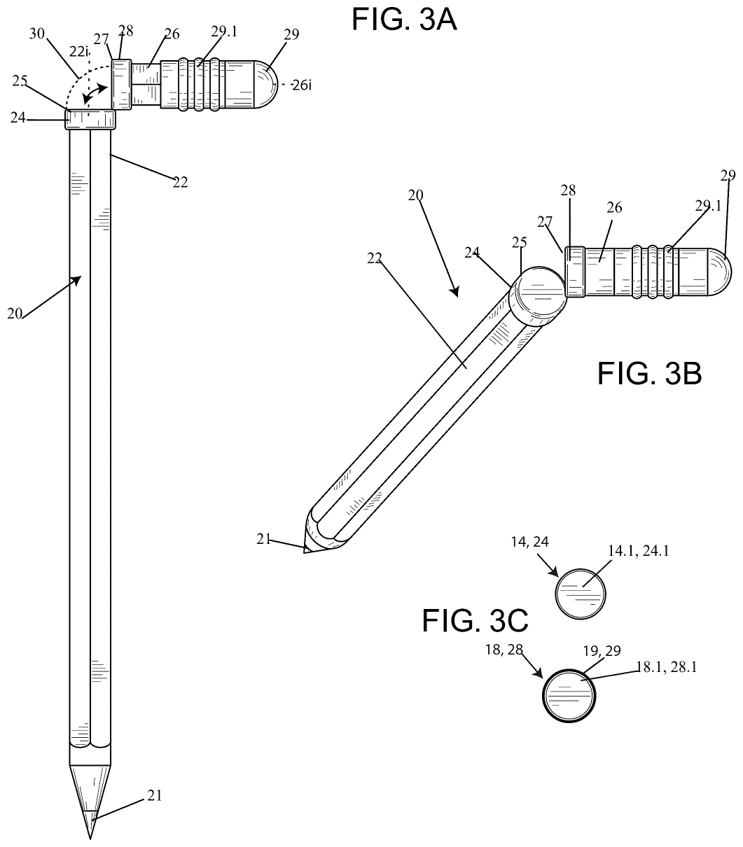

FIGS. 3A and 3B show a side view and a perspective view of the second embodiment 20 which shows the first body section 22 having a writable end 21 and having a longitudinal axis of 22i. The second body section 26 is coupled to clamp or ferrule 29.1 and eraser 29 and has a longitudinal axis of 26i. The coupling of the first body section to the second body section is via magnets 24 and 28. While magnets 24 and 28 can have any suitable shape, in this embodiment there is shown a beveled edge 25 on magnet 24 and a beveled edge 27 on magnet 28. The contact between the two magnets 24 and 28 is along these beveled edges. The magnets stay coupled together via a magnetic attraction force generated by each of the magnets.

FIG. 3C shows the end views of each of the magnets 14, 24, and 18, and 28. Magnets 14 and 24 each have an end surface 14.1, and 24.1 while magnets 18 and 28 each have end surfaces 18.1 and 28.1. As shown extending out radially beyond the magnets 18 and 28 radial extension, is the respective eraser 19 and 29. It is these end surfaces 14.1 and 18.1 on the first embodiment and 24.1 and 28.1 on the second embodiment which allow the two body sections to align and connect with each other when the device is not in use or being spun. The spinning of the first magnet 14 and 24 around the respective second magnet 18 and 28 occurs when the user grasps the second body section 16 (See FIG. 2) and 26 in their hands and then rapidly rotates their hand to cause the first body section 12 (See FIG. 2) and 22 to move into an angle offset from coaxial with the second body section to a position wherein the first body section is substantially perpendicular or substantially at a right angle to the second body section. This causes the first respective magnet 14 (See FIG. 2) and 24 to separate from the second respective magnet 18 (Sec FIG. 2) and 28 and to remain in contact along an edge of each magnet such as along each respective beveled edge 15 and 17 (See FIG. 2) of the first embodiment or 25 and 27 of the second embodiment. In addition, the connection can also be along the faces of the magnet and not just on the edges of the magnet. For example, one edge can contact the side face, or the edge can be in contact with the top face, or a top face of one magnet can be in contact with a side face of another magnet.

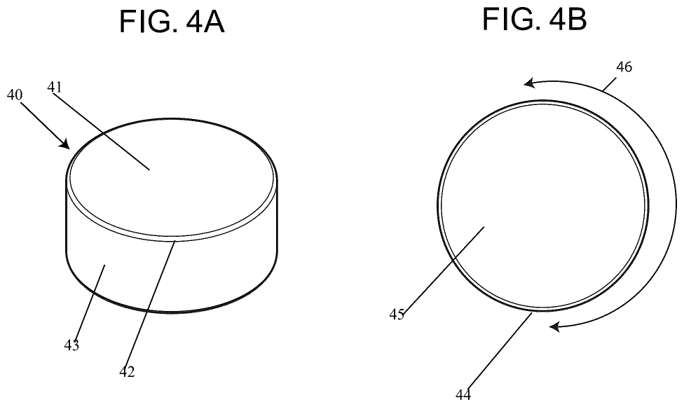

FIG. 4A shows a top perspective view of an example of a magnet 40 having a top surface 41, a side radial surface 43 and a beveled edge 42. FIG. 4B shows the bottom view which shows the bottom surface 45 and the beveled edge 44. This type of magnet is one example of a magnet that can be used however any suitable magnet can be used. The bottom surface 45 can be used as a surface to adhere the magnet to any suitable adjacent body such as the first body 12 or 22 or the second body 16 or 26. The means of adherence or coupling can be in any suitable manner such as with a fastener, such a clamp crimp or clasp, an adhesive such as glue, epoxy, or any other suitable pliable adhesive. Other forms of fasteners can be used such as a nail, a rivet, a screw (threads) or any other suitable form of coupling including a separate cap or ferrule to hold the magnet and connect on to an adjacent body section. FIG. 4B also shows path 46 that another magnet may move around magnet 40 when the two magnets are coupled together but spun around each other. For example, a side surface 43 of a first magnet can rotate around either another side surface 43 of another adjacent magnet, or the side surface 43 of one magnet can rotate around on the top surface 41 of an adjacent magnet. Alternatively, a beveled edge 44 on one magnet can rotate around a side surface 43 of an adjacent magnet or around the top surface 41 of an adjacent magnet. These surfaces and interactions described above also apply for an interaction between covers such as cover 412 described below. During the rotation of a magnet vs. another magnet or a magnet vs. a cover or two separate covers, the movement of the two adjacent bodies can be such that the interaction can change from contact on either the top face 41 the beveled edge 42 or the side face 43 as each of the magnets or covers are moving vs. each other.

While the rotation of one magnet or magnet cover is described as rotating around an adjacent magnet or magnet cover on a beveled edge, the interaction between these two magnets and/or covers can be either on each of the beveled edges, or between a beveled edge of one ferrule or cover and a flat edge of an adjacent ferrule or cover, or a beveled edge of a first magnet and a straight edge or an adjacent magnet or between two flat edges of adjacent magnets or covers.

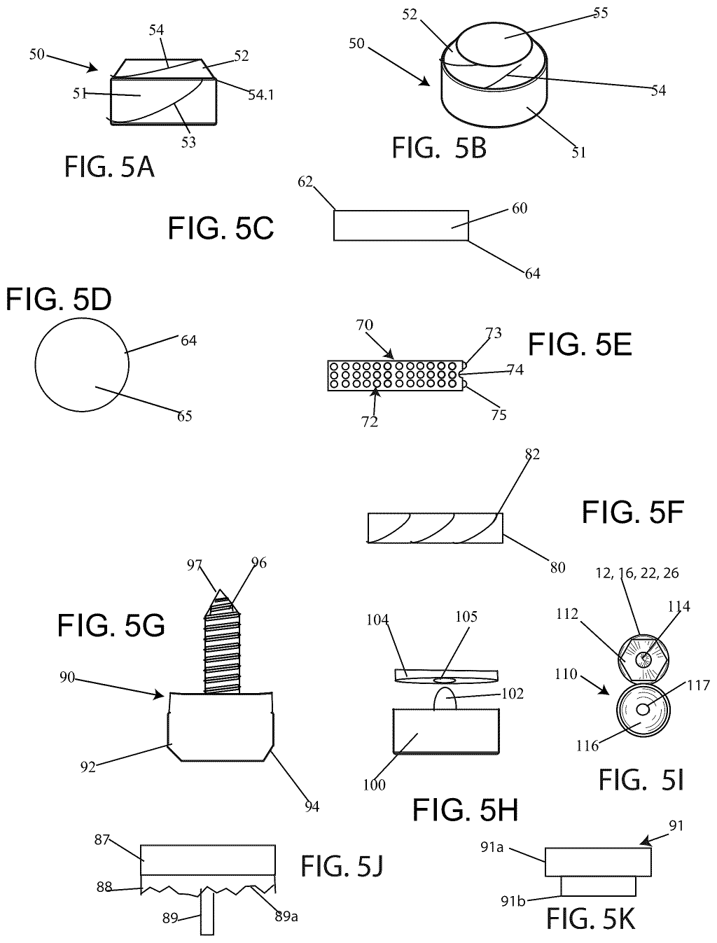

FIGS. 5A-5K show the different types of magnets that can be used. For example, there is shown a magnet 50 which has a radial surface 51 having a thread 53 a beveled edge 54.1 extending inward. There is also a frusto-conical section 52 extending up from the radial surface 51 which narrows as it extends away from the radial surface 51. There is also a thread 54 shown on this surface as well. This surface 52 can also support stippling 72 (See FIG. 5E) indents, detents, or any other type of surface modification. FIG. 5B shows a perspective view of this embodiment 50 as well which shows radial surface 51 without groove or thread 53, but with grooves 54 on surface 52. This view also shows top surface 55.

FIG. 5C shows another type of magnet 60 which has a sharp non beveled edge 62 and another sharp non beveled edge 64. With this design, the magnet has substantially right angle edges which still allow for some connection and which allow for a first body such as anyone of bodies 12 and 22 to rotate around the respective second bodies 16 and 26. FIG. 5D shows the top surface 65 having edge 64 of the embodiment of FIG. 5C

FIG. 5E shows another type of magnet 70 which has along its radial surface stippling 72 which is formed in any suitable pattern, and which has corresponding protrusions 73 and 75 as well as indents 74. This stippling 72 can provide a suitable ratchet like connection between the magnets which creates an enhanced audible sound and feeling of friction and interaction between two magnets that intersect each other.

FIG. 5F shows a side view of magnet 80 which has threads or grooves 82 extending along the outer radial surfaces of the magnet. The threads can operate in a manner similar to the stippling which thereby provides an enhanced interaction between the two magnets.

FIG. 5G shows a side view of another embodiment 90 which shows a base section 92 comprising a magnet, a radially inner extending section 94 which has a frusto-conical shape, extending in from the base section, and a screw or threaded section 96 having a tip 97. Essentially this type of magnet 92 can then be screwed into associated body sections such as any one of body sections 12, 22, 16, 26 to couple the magnet 90 to the body sections.

FIG. 5H shows a coupling between a magnet 100 having a rivet protrusion 102 and a corresponding plate 104 having a hole 105 configured to receive the corresponding rivet protrusion. Plate 104 is then secured to any one of the body sections 12, 22, 16, 26. Then to secure the magnet to the body section, the protrusion 102 is pressed into the plate with protrusion extending through hole 105 and then being secured with friction fit or with a lock between the rivet protrusion 102 and hole 105 to secure plate 104 to magnet 100.

FIG. 5I shows the end view of any one of the body sections 12, 16, 22, and 26 which is selectively secured to a coupling plate or clasp 112, and which has a protrusion 114 extending out from this end. The corresponding magnet 116 has a hole 117 therein, wherein the magnet can then be pressed against plate 112 and secured to plate 112 via protrusion 114 extending through hole 117.

FIG. 5J discloses a magnet 87 having a roughened section 88 with a roughened surface 89a and a shaft 89. This roughened surface 89a is configured to allow for increased interaction when pressed against a wooden or plastic surface or body section such as a pencil or a pen.

FIG. 5K is another view of another embodiment which shows a magnet 91 which has a section 91a which can rest outside of an adjacent body and an internal portion 91b which is configured to fit at least partially inside of an adjacent body. While the shapes of the magnets have been shown, these shapes and surface treatments are also applicable to the covers for these magnets as well.

In addition, each of the magnets can receive a coating to reduce wear or to increase or improve the surface interaction between the magnets. For example, the magnets can be coated with an epoxy, painted, coated with a plastic or other metallic surface treatment such as with electroplating or chemical vapor deposition, or separate metal, plastic, carbon fiber, or any other suitable material to protect the magnets.

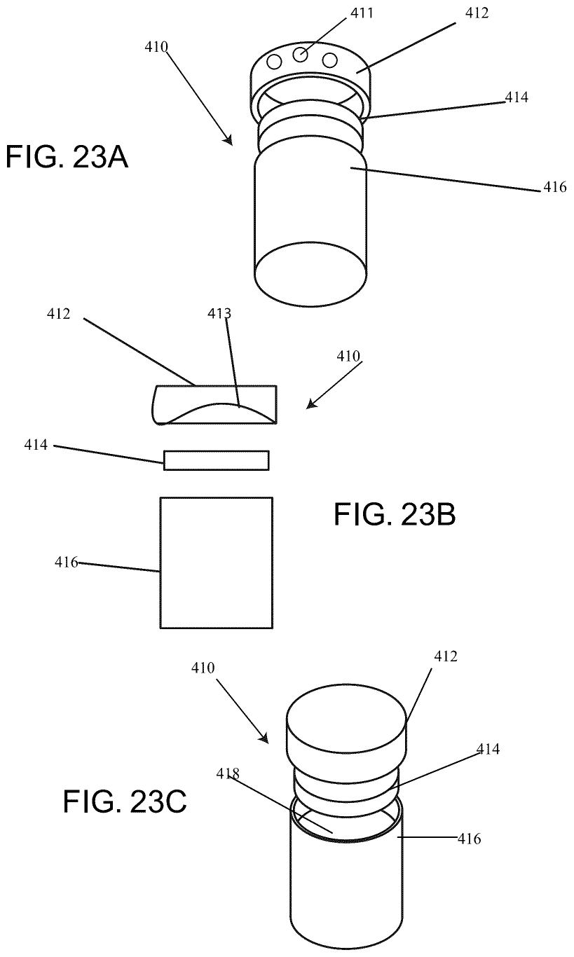

While many examples of surfaces have been shown as well as fasteners for fastening the magnet to corresponding body sections, and while many different types and shapes of bodies have been shown any suitable magnet can be used having any suitable shape, suitable surface and suitable fastener to achieve the effect of having one body spin radially around the second body with the first body being coupled to the second body via magnetic attraction. Magnet shapes for fidget only include square, rectangle, triangle, octagon rectangle. The different shapes, and surface treatments shown on the magnets of FIGS. 5A-5K can also be applied to the covers for the magnets described below (See for example cover 412 in FIG. 23B).

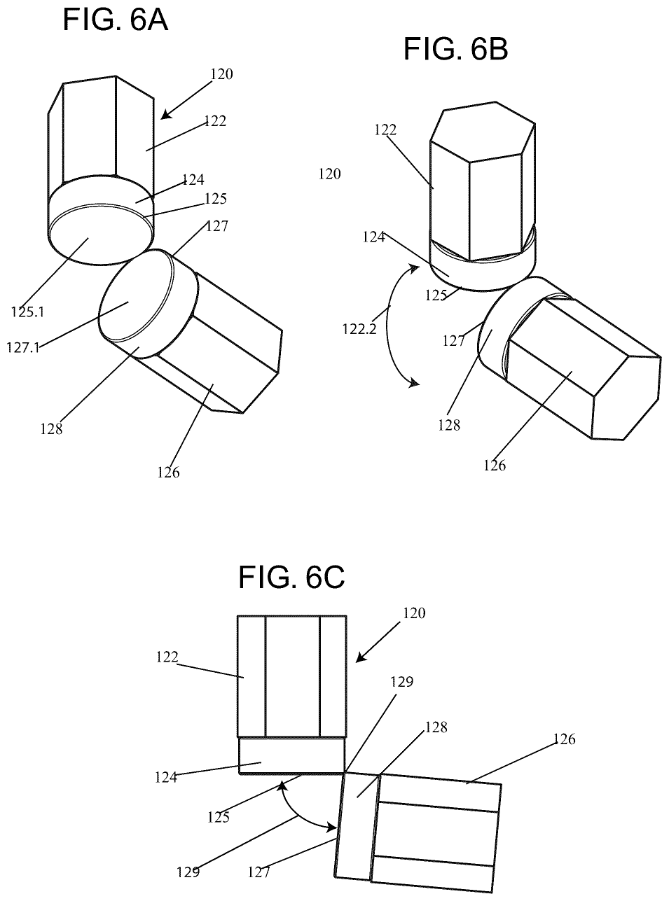

FIGS. 6A-6C show examples of the interactions between the first body and the second body via the embodiment 120. In this embodiment, first body 122 has magnet 124 wherein the magnet has a beveled edge 125 and an open surface 125.1. The second body 126 has a corresponding magnet 128 having a beveled edge 127 and an open surface 127.1. The open surfaces 125.1 and 127.1 are substantially not in contact with each other but the two magnets are in contact with each other along their respective beveled edges 125 and 127 or sides. While the connection or contact can be along the beveled edges the contact can also be along the sides of the magnet(s) as well. For example, contact can be along a side or top face 125.1 and/or the side face 125.2 of the magnets as well.

In particular, FIG. 6C shows that the angle of this interaction between the first magnet 124 and the second magnet 128 is not at a right angle (see angle 129) or perpendicular intersection. FIG. 6B also shows the path 122.2 that first body 122 spins around second body 126 when first magnet having beveled edge 125 rotates around second magnet 128 having beveled edge 127, with the beveled edge 125 being in contact with beveled edge 127. The rotation of first body section 122 around second body section 126 can occur when first body section having magnet 124 rolls around magnet 128 on their respective beveled edges or sides or the first body section and corresponding magnet 124 slides along second magnet 128 of second body section as first body section 122 rotates around second body section 126.

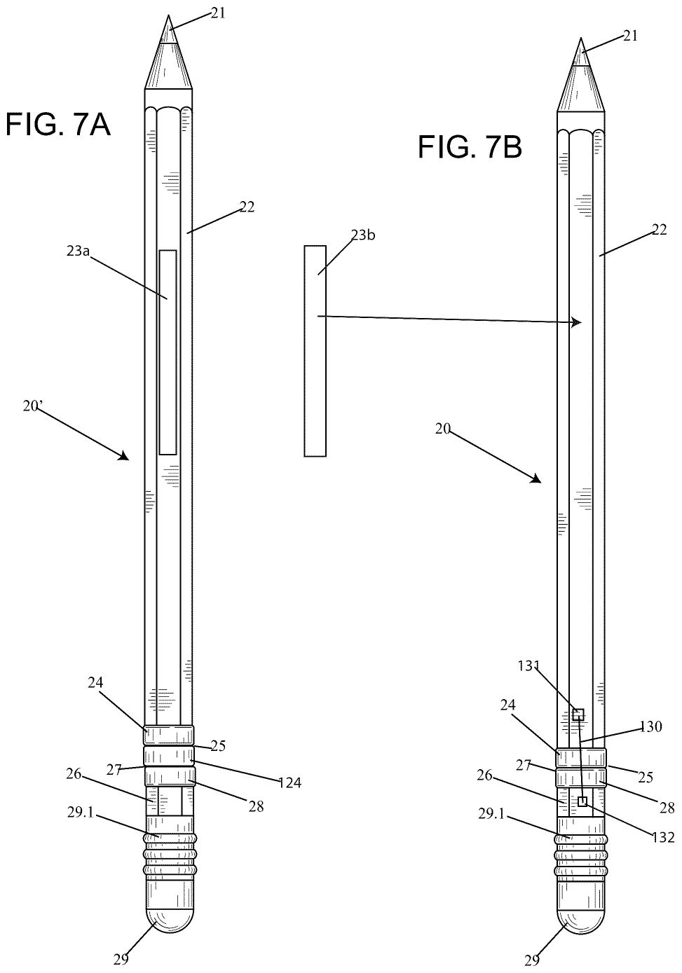

FIG. 7A shows another embodiment which shows body section 22 coupled to body section 26 via three different magnets 24, 124, and 28. With this embodiment 20′ there is shown beveled edges 27 and 25 on the magnets. In addition, there is shown clamp or ferrule 29.1 as well as eraser 29 coupled to body 26 via clamp or ferrule 29.1. This third magnet 124 is not secured to any of the other body sections, it simply remains in place via its common magnetic force with the other surrounding magnets. Magnet 124 is not fixed to either of the other magnets 24 and 28. Magnet 124 is essentially freely floating between these two magnets and held in place via the magnetic attraction between these two magnets. FIG. 7A shows an additional strip or material which can be coupled to the writing implement or body section 22. This strip of material 23a can be in the form of a reflective strip or a glow in the dark strip or a decal which can be coupled to or painted onto the body section.

FIG. 7B shows a side view of the second embodiment 20 which shows a first body section 22 having tip 21 a first magnet 24 coupled to first body section 22 the first magnet having a beveled edge 25. The second body section 26 has magnet 28 having a beveled edge 27. There is a clamp or clasp or ferrule 29.1 which secures the eraser 29 to the second body section 26. There is also a connector 130 which is secured at a first end to the first body section 22 via a fastener 131 and is secured at a second end to second body section 26 via a fastener 132. Connector 130 is configured to allow the first body section to rotate around the second body section while still preventing the first body section from rotating away from the second body section. FIG. 7B shows another strip 23b which can be attached to the body section 22 as a stick-on material. This material can be in the form of a decal, glow in the dark strip, or a reflective strip as similar to the painted on or embedded strip 23a listed above.

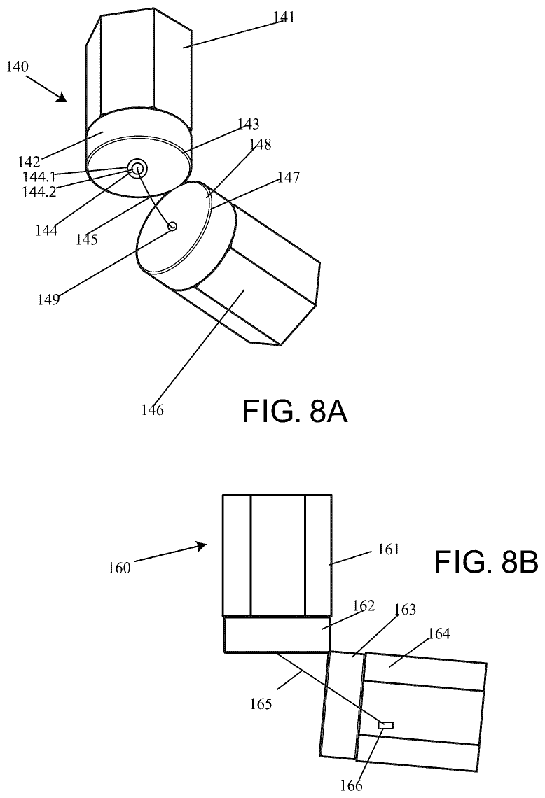

FIG. 8A shows another embodiment 140 which shows one of the different ways in which the two body sections can be coupled together. For example, there is shown a first body section 141 having a magnet 142 having a beveled edge 143. There is a rotatable cylinder 144 having an outer cylinder 144.1 and an inner chamber 144.2. Coupled to the rotatable cylinder 144 is a connector 145. Connector 145 is secured to body section 146 by extending through a hole 149 in magnet 148. Inner chamber 144.2 rotates inside of outer cylinder 144.1 via a set of bearings. The second magnet 148 has a beveled edge 147 and is connected to second body section 146. The rotation of the inner chamber 144.2 allows for the connector 145 to remain untangled when the different body sections are rotating vs. each other.

As shown in FIG. 8B, In another embodiment 160 there is a first body section 161, a second body section 164, a first magnet 162, a second magnet 163 and a connector 165 which is coupled to a center region of the magnet 162 at a first end and to a side of the second body section 164 at via a fastener 166 at the second end.

Thus with all of these designs there is created different types of magnets, different types of bodies and different types of connectors, wherein any one of the bodies can be coupled to any one of the magnets and optionally use any one of the connectors to create a suitable device which allows the first body section to rotate around the second body section wherein the first body section is coupled to the second body section via a magnetic field.

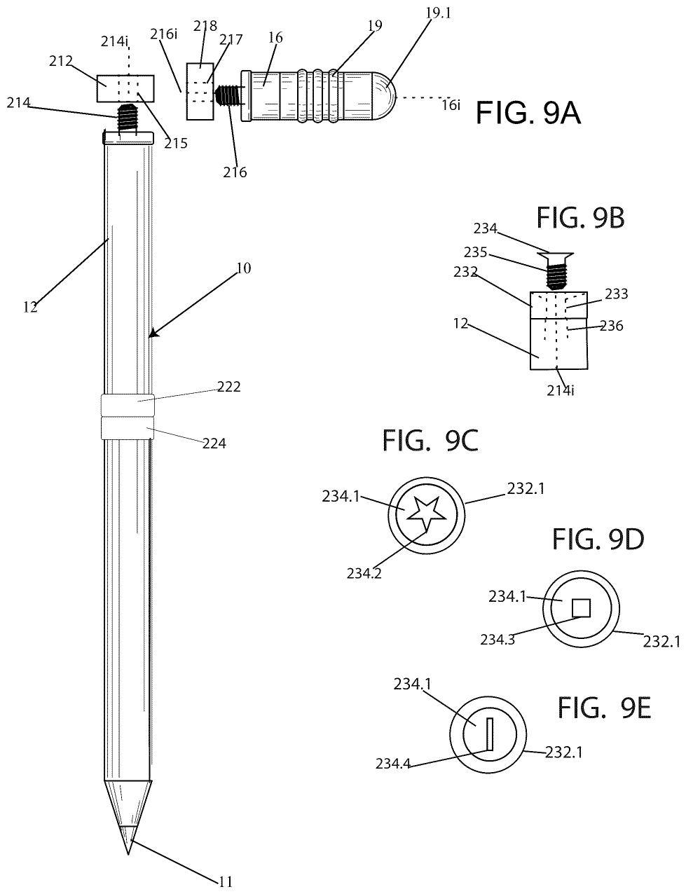

FIG. 9A is another view of another design which includes a first body 12 of a pencil device 10 and a second body 16. Coupled to first body 12 is a threaded section 214 which is coupled to body 12 and extends out from first body along longitudinal axis 214i. In addition, coupled to second body section 16 is a threaded section 216 which extends along axis 216i which is essentially along the longitudinal axis of body section 16. These threaded sections 214 and 216 are coupled to the respective body sections via any known fastening means such as clamp, rivet, screw, adhesive etc. There are magnets 212 and 218 as well. Magnet 212 is configured to be screwed onto threaded section 214 via its own complementary threads 215. Magnet 218 is configured to be screwed onto threaded section 216 via its own complementary threads 217 along axis 216i. There is also an optional additional set of magnets 222 and 224 which are positioned farther along body section 12 which allow for additional spinning and magnetic connection similar to that of magnets 212 and 218.

FIG. 9B is a view of another magnet connection wherein magnet 232 is coupled to a body section 12 via a screw 234. Magnet 232 has a counter sunk region 233 while there are threaded region or drill section 236 in body section 12 as well. The screw 234 can be inserted into magnet 232 and body section 12. As shown in FIGS. 9C-9E this shows the top face 234.1 of screw 234 positioned concentric but inside of the top face 232.1 of magnet 232. For example, as shown in FIG. 9C on a top face 234.1 of screw 234 is a notching such as a Phillps head receptacle 234.2 (See FIG. 9C) or Allen wrench receptacle 234.3 (See FIG. 9D) a flat head screwdriver receptacle 234.4 (FIG. 9E) to receive either a Phillips head screwdriver or an Allen wrench or, a flat head screwdriver other suitable tool to tighten screw 234 into the body section.

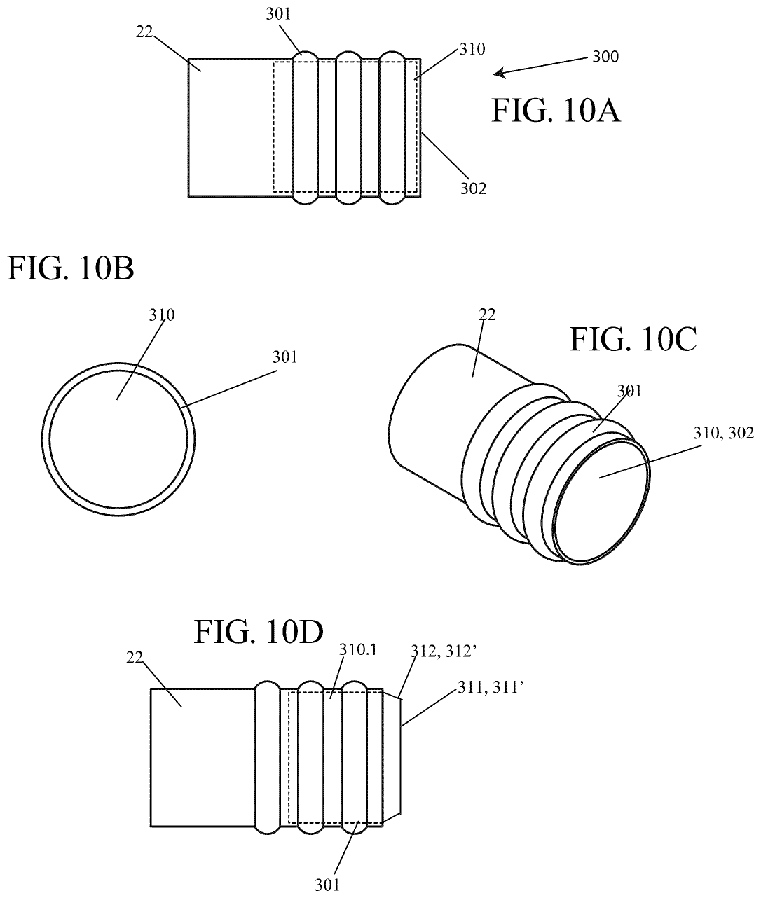

FIG. 10A is a view of another embodiment 300 which includes a ferrule 301 which is configured to house or contain a magnet 310 which is stored inside of a body or shaft 22. Ferrule 301 can be formed from a corrugated metal cylinder which can be crimped around the body or shaft 22. An end portion 302 of ferrule 301 can be used to cover the magnet 310. Because as shown in FIG. 10A end portion 302 covers magnet 310 this metal can then protect the magnet from further wear and tear as two different magnets may move against each other. FIG. 10B shows the end view of the view in FIG. 10A wherein this end view includes magnet 310 shown not covered by end portion 302 but rather exposed. In this view the magnet is shown embedded in the ferrule but having its end portion exposed so that it can have direct interaction with other magnets.

FIG. 10C shows the perspective view of either versions of FIGS. 10A and/or 10B which have either a covered magnet via end portion 302 or an open and exposed magnet 310 at this end portion.

FIG. 10D shows another version which shows shaft or body portion 22 which is coupled to ferrule 301. Disposed inside is a magnet 310.1. In this view there is an angled portion 312 and/or 312′ and a flat portion 311 and/or 311′. Angled portion 312 and flat portion 311 form the angled portion and flat portion of the magnet itself 310. Alternatively, in another embodiment, the angled portion of the magnet and flat portion of the magnet can be covered by a non-magnetic cover portion of the ferrule 301 formed by angled portion 312′ and flat portion 311′.

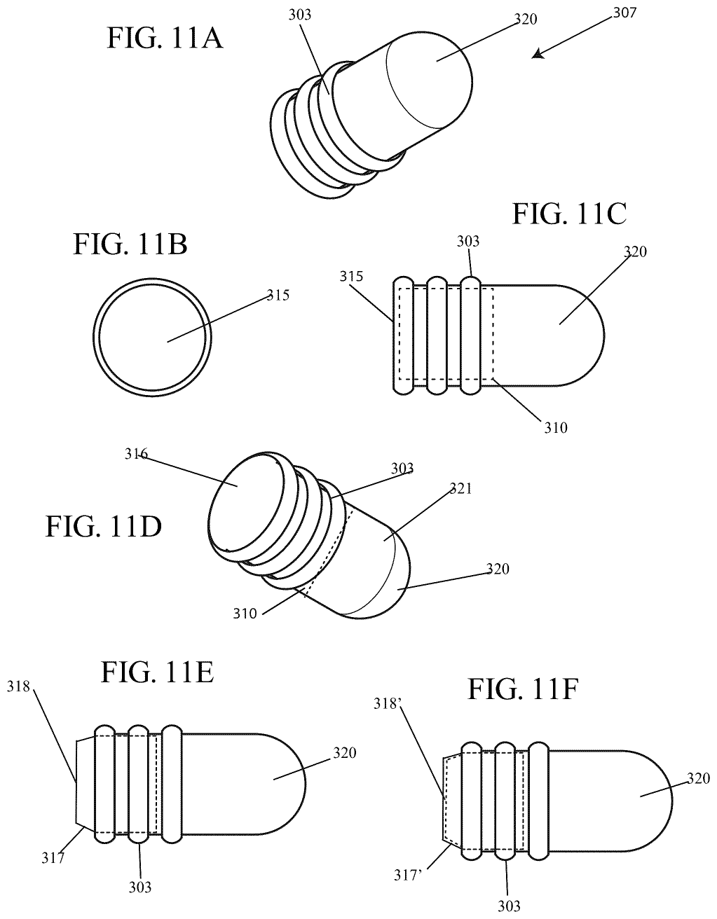

FIG. 11A shows another embodiment which shows a perspective view of a ferrule 303 which is coupled to an eraser 320. FIG. 11B shows an end view which shows an end covering portion or cover 315 of the ferrule 303 which is configured to house a magnet 310. FIG. 11C shows a side view of the eraser device 320 which has ferrule 303, cover 315 and magnet 310. Cover 315 can be made of a hardened nonmagnetic but magnetically conductive material such as a metal such as aluminum or a ferrous material or plastic or carbon fiber. FIG. 11D shows a perspective view of another embodiment which shows ferrule 303, eraser 320 having a first section 321, a second section 320 and an open section at the end of the ferrule 303 for allowing for an open uncovered face 316 of magnet 310.

FIG. 11E shows a side view of another embodiment which shows eraser 320 coupled to ferrule 303, magnet 310 is disposed inside of ferrule 303. In addition, there is a beveled section 317 and a flattened section 318 extending out from ferrule 303. In this embodiment beveled section 317 is coupled to magnet 310 while flattened section 318 is considered part of magnet 310 as well. In the embodiment of FIG. 11F, the beveled section 317′ is formed as part of the ferrule and covers the magnet while the flattened section 318′ is a cover over the magnet and is formed as part of the ferrule as well.

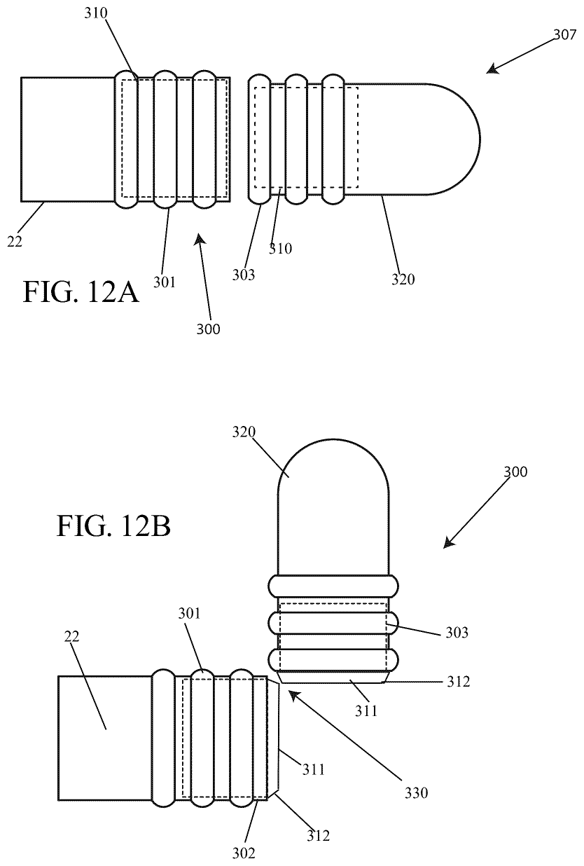

FIG. 12A shows the combination of the embodiments of FIGS. 10A-10D and 11A-11F put together. For example, there are shown the embodiments of 300 and 307 which are put together to form a spinning device. In this embodiment, device 300 includes ferrule 301 which locks magnet 310 to body 22. Ferrule 303 also locks magnet 310 inside of eraser section 320. Thus, as shown in FIG. 12B the embodiment 300, ferrule 301 can be rotated versus ferrule 303 around a side of the ferrule or cover or around a beveled edge or edge 312.

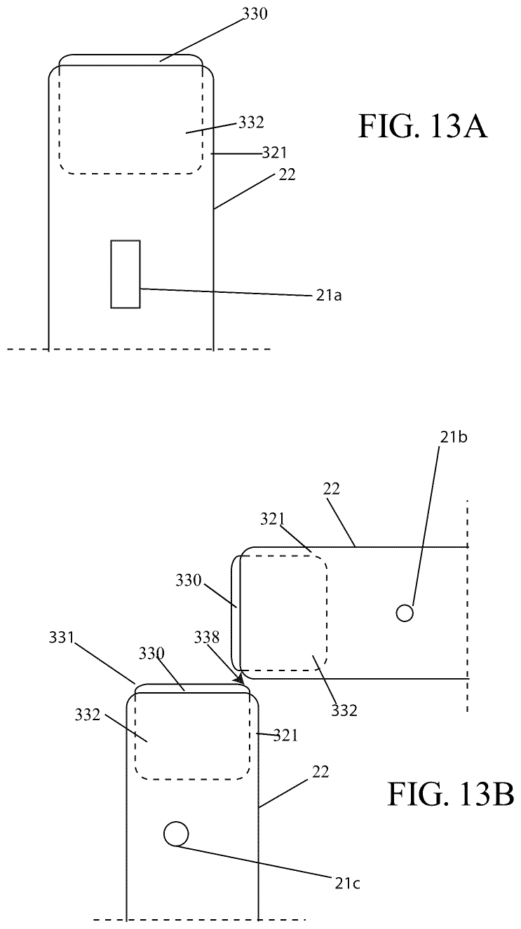

FIG. 13A shows a side view of another embodiment which shows body 22 which houses magnet 330 in a recessed portion 321. The covered section of magnet 330 is shown by portion 332. Body section 22 includes a glow strip or glitter strip 21a for visual effect.

FIG. 13B shows a side view which shows two of these types of bodies 22 for holding magnets 330 wherein each of these bodies are in contact with each other at a transverse angle along an intersection point 338. The transverse angle can be formed as a 90-degree angle or any suitable transverse angle such as an 85-degree angle or any angle between 60 degrees offset or upwards of 120 degrees offset or any angle in between. This view also shows that bodies 22 have respective lights 21b and 21c in each of these bodies to provide a visual effect(s). This view also shows body sections 22, recessed portions 321, magnet portion 332 of magnet 330.

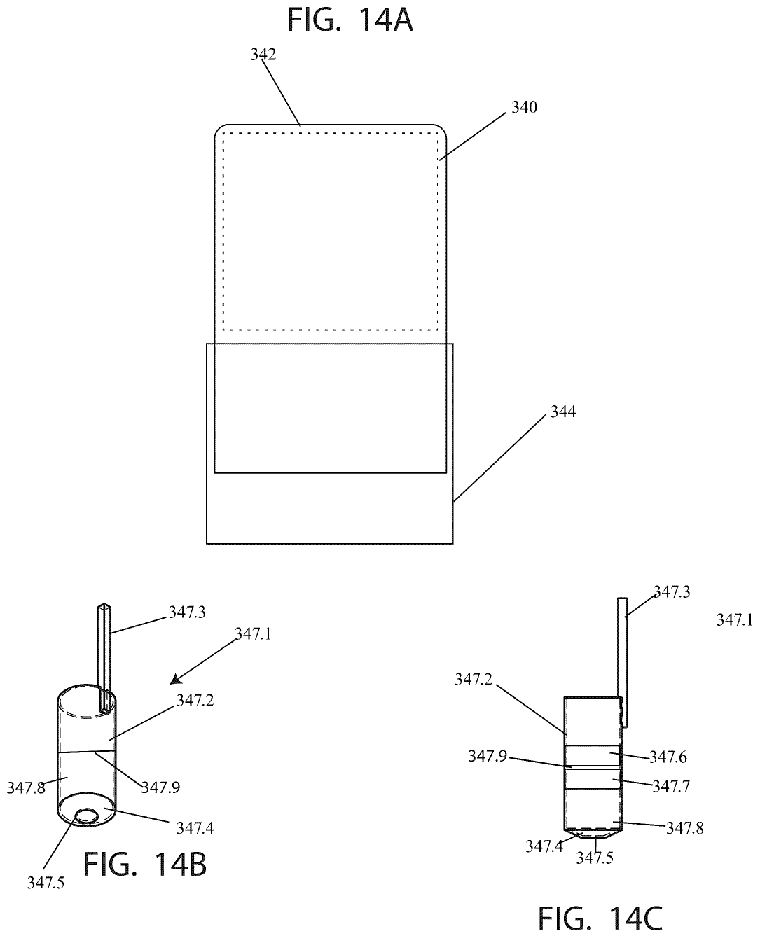

FIG. 14A shows another embodiment which shows a main body 344 which is similar to body 22, wherein there is a container, or cover 342 which is configured to contain a magnet 340. This type of device can be used with any of the devices discussed previously as well.

FIG. 14B is a side perspective view of a split cap embodiment 347.1 the split cap 347.1 is configured to sit on top of an instrument such as a writing instrument. The split cap 347.1 has a first body section 347.2 that is split at split point 347.9, so that the cap has a second separate body section 347.8 and therefore forms two separate bodies. First body section 347.2 has clip 347.3 and second body section 347.8 has a rounded end having end pieces 347.4 and 347.5. As shown in FIG. 14C there is split point 347.9 dividing body section 347.2 from body section 347.8. Disposed in the first body section 347.2 is magnet 347.6. Disposed in the second body section 347.8 is magnet 347.7. This view also shows end pieces 347.4 and 347.5 as well. An instrument such as a writing instrument can then be inserted into body section 347.2 and releasably fixed thereto. A user can hold body section 347.8 and then separate the body sections such as shown in FIG. 2A at a substantially perpendicular angle and then have magnet 347.6 rotate around magnet 347.7 in a manner described above such as in FIG. 4B. Each of these magnets 347.6 and 347.7 can be optionally covered with a cap, a coating or any other type of covering to save on wear on the magnets.

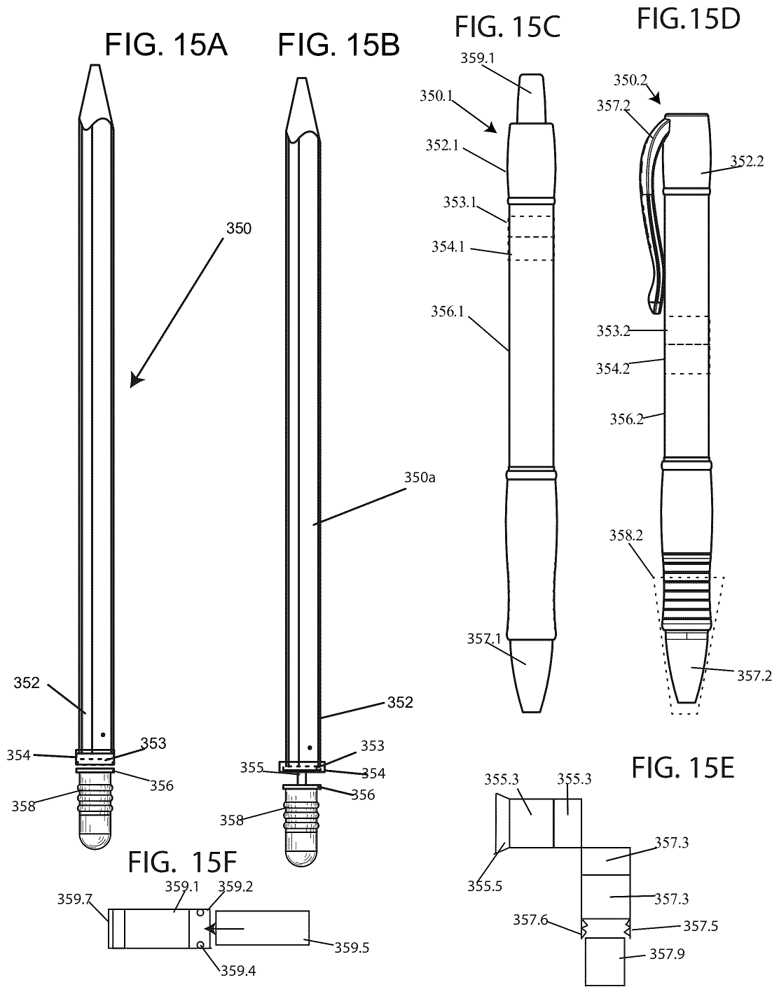

FIG. 15A is a side view of another embodiment 350. In this embodiment, there is a body section 352, a plurality of different magnets 353, and 356. Magnet 353 is disposed of inside of ferrule 354. These magnets are disc shaped magnets which are positioned adjacent to ferrule 358. As shown the size of the different ferrules 354 and 358 can be different such that for example the ratio of the size of the first ferrule 354 vs. the second ferrule 358 can be in a ratio of 1:1, 1:2, 1:3, 1:4 or any other suitable ratio. These ratios can also be reversed between the first ferrule 354 and the second ferrule 358.

FIG. 15B is a side view of another embodiment 350a which shows body 352, two separate magnets 353 and 356 which are bound together with clastic line 355. In this view there are magnets 353 and 356 separated by line 355 which is a cable or elastic string connecting both the body 352 and the ferrule 358 together. As shown magnet 353 is coupled to the body 352 via ferrule 354. Magnet 356 is coupled to ferrule 358.

FIG. 15C is a side view of an embodiment with a pen 350.1. This embodiment includes a first section 352.1 a magnet 353.1 coupled to first section 352.1. Magnet 353.1 is disposed inside of second section 352.1 such that magnet 353.1 is either entirely, largely (95% or greater) or substantially (80% or greater) housed inside of second section 352.1 There is also a second magnet 354.1 coupled to second section 356.1. This second magnet is also either entirely, largely or substantially housed inside of second section 356.1 The magnets 353.1 and 354.1 are separable and can be positioned either flush with each other such as shown in FIG. 15C or at a substantially 90-degree angle (90 degrees +/−15 degrees) see FIG. 15E. There is also an eraser 359.1 disposed at one end. At the opposite end is a conical tip 357.1 which is rotatable to allow for advancement of either a pencil portion (graphite rod) or a pen tip to allow for writing. The body sections 352 and ferrule 358 are separable via the magnetic connection between magnets 354 and 356. Body sections 352.1 and 356.1 are separable from each other via magnetic connections between magnets 353.1 and 354.1. Body section 352.2 is separable from body section 356.7 via magnetic connection via magnets 353.2 and 354.2.

FIG. 15D is a side view of an embodiment with a pen and a clip and a cap. This embodiment 350.2 includes body section 352.2 magnet 353.2 coupled to body section 352.2. There is also magnet 354.2 coupled to body section 356.2. There is also a clip coupled to body section 352.2. Clip 357.2 can be a standard clip for a pen but the presence of clip 357.2 forces the position of the magnets 353.2 and 354.2 to be positioned in this example towards the center of the pen. The size of the clip 357.2 can be of any suitable size such as a microclip so the magnets do not have to be repositioned. At one end is a conical tip 357.2 which is rotatable to allow for advancement of either a pencil portion (graphite rod) or a pen tip to allow for writing. FIG. 15E is a side view of the magnets for use with the embodiments of FIGS. 15A-15D. In this embodiment there are alternative means for coupling the different magnets to an adjacent pen or pencil. For example, there is shown at one end a body section 355.3 which is coupled to magnet 355.3 at one end. At the opposite end is a crimp on or clamp on interface 355.5 which allows body 355.3 to be crimped on or clamped on to a body section of an adjacent device such as an adjacent body section of a pen or pencil. There is also disclosed an alternative design which has body section 357.3 which has an attachment end 357.5 having threads 357.6 which allow for screwing onto an adjacent body section such as body section 357.9 of a pen or pencil or another object.

FIG. 15F is a view of another embodiment which shows a body section 359.1 which is configured to hold a magnet 359.7. There is a connection end 359.2 which is an open cylinder which has a gasket or rubber O-ring 359.4 which is configured to receive the body section 359.5 of an adjacent pen, pencil or other object for connecting to a magnet.

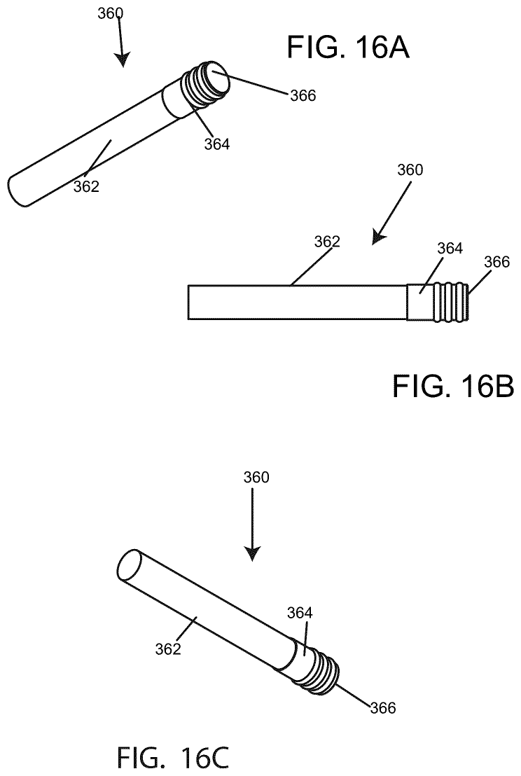

FIG. 16A is a perspective view of another embodiment 360 which has body section 362, as well as ferrule 364. There is also magnet 366 positioned at the end of ferrule 364.

FIG. 16B is a side view of the embodiment of FIG. 16A which shows embodiment 360 which has body section 362 with ferrule 364 coupled to body section 362. Coupled to ferrule 364 is magnet 366 which extends at least to the end of ferrule 364.

FIG. 16C is another perspective view of the embodiment of FIG. 16A which shows embodiment 360 having body section 362 ferrule 364 and magnet 366. Body section 362 can be in the form of a pen or pencil body.

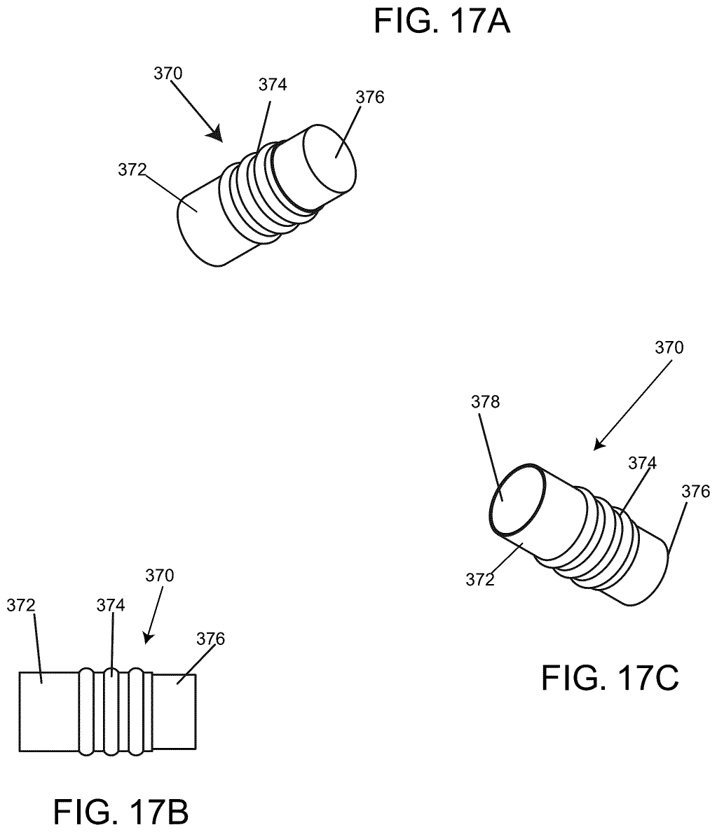

FIGS. 17A and 17B are perspective and side views of another embodiment of a ferrule for use with a magnet, wherein with this embodiment 370, there is body section 376 which can be in the form of a body section 376 which is a body section of a pen or a pencil or other instrument. Ferule 374 connects to body section 376 and extends with a side cover 372 for covering a magnet 378 (See FIG. 17C).

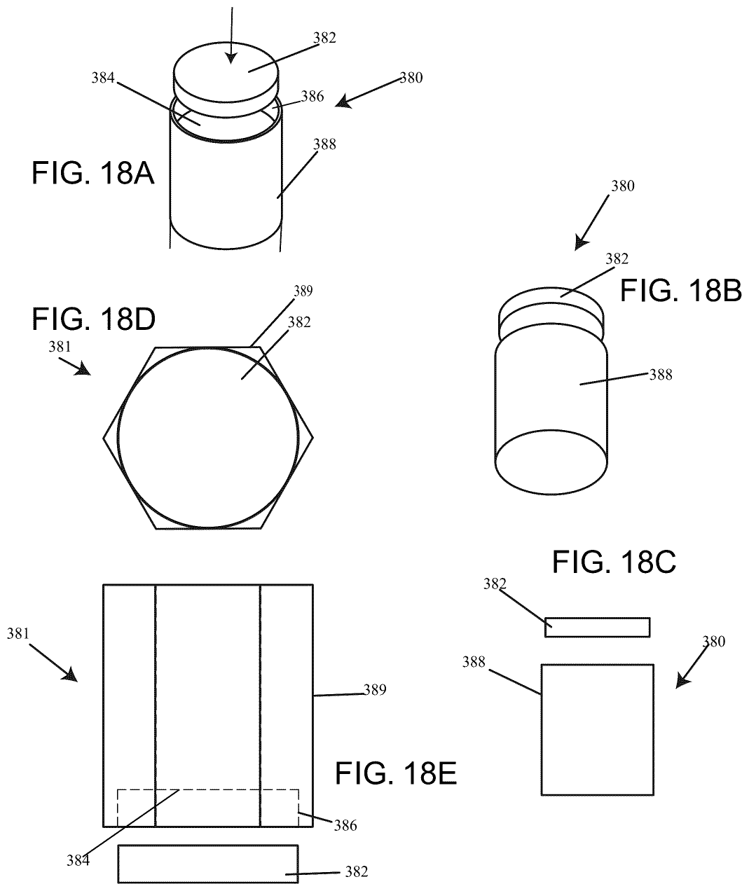

FIG. 18A is a perspective view of another embodiment 380 which shows a body section or ferrule 388 which has an indented section having an end surface 384 as well as a side wall 386 which is configured to receive a magnet 382. See also side perspective view 18B and side view 18C as well.

FIG. 18D is a top view of another embodiment 381 which has a body section or ferrule 389, which is configured to receive magnet 382. FIG. 18E is a side view of the embodiment 381 of FIG. 18D, in this view there was body section or ferrule 389 which had an embedded magnet receptacle having a base surface 384 and a side surface 386 for receiving a magnet 382. The magnet 382 can be secured or fastened therein via any fastening means.

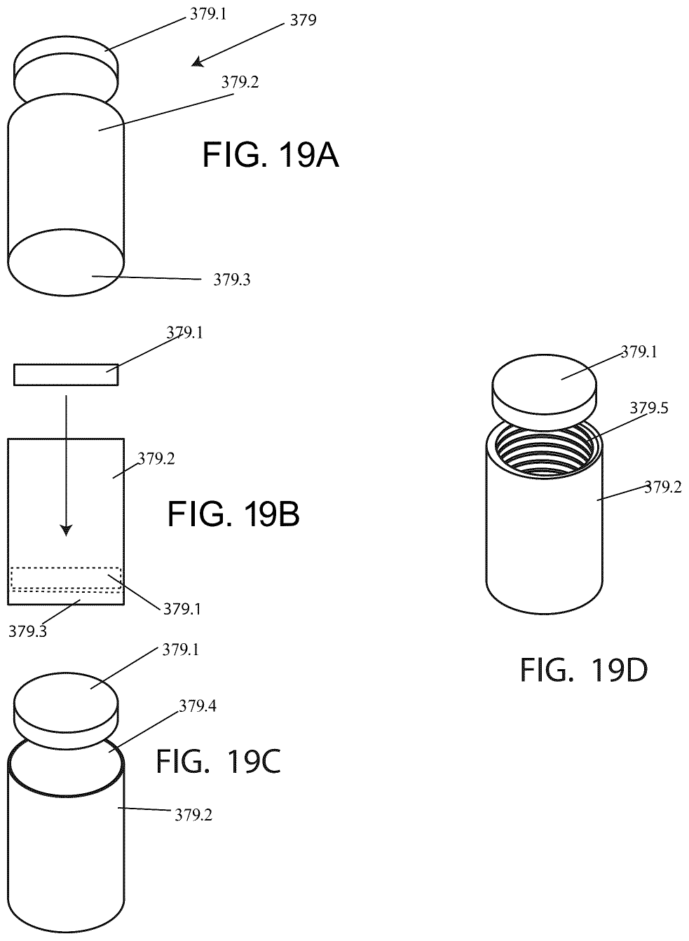

FIG. 19A is a bottom-side perspective view of another embodiment 379 which shows a magnet 379.1 which is configured to sit inside of a cap or ferrule body 379.2. Cap or ferrule body 379.2 has a closed end 379.3.

FIG. 19B is a side view of the cap/ferrule embodiment 379 which shows magnet 379.1 which is configured to fit inside of cap body 379.2. This magnet is configured to sit against closed end 379.3.

FIG. 19C shows a top perspective view of the embodiment which shows the magnet is configured to fit into the open end 379.4 slide down into the body section 379.2. This open end 379.4 is configured to receive a body section of a pen or a pencil so that when the pen or pencil is slid inside the cap or ferrule body 379.2 is configured to attach to the body section of a pen or a pencil or other object via any known fastening means such as through a threaded engagement, crimping on or through an adhesive.

FIG. 19D shows another embodiment of a cap or ferrule which shows the body section 379.2 which has an interior threaded region 379.5 for screwing onto a body section of an adjacent pen, pencil or other object. This occurs after the magnet 379.1 is dropped into the cap.

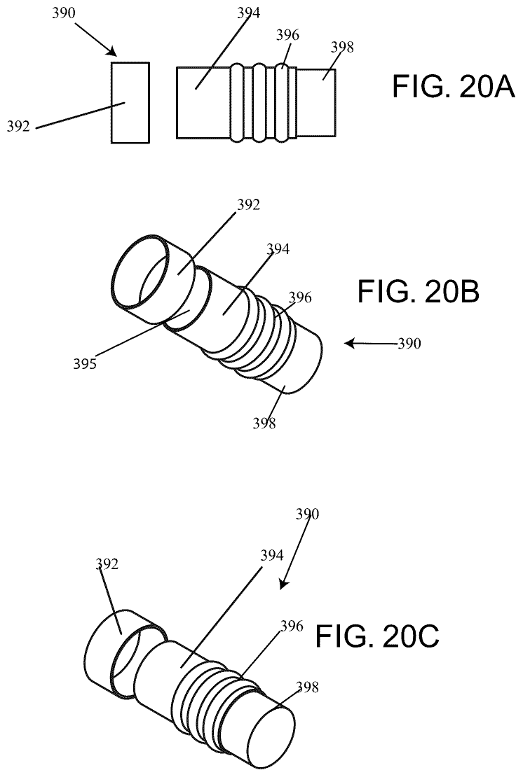

FIG. 20A is a side view of another embodiment 390 which shows ferrule 396 having ends 398 and 394 as well as cap 392. Cap 392 can be secured to end 394 via either friction fit or via screwing onto the ferrule 396. FIG. 20B shows a perspective exploded view of the embodiment which has the ferrule 396 and the cap 392 which can be coupled to the ferrule to cover a magnet 395 which can be embedded into the end portion of the ferrule 396. FIG. 20C is a side perspective view of the embodiment of FIG. 20A which shows ferrule 396 which has ends 394 and 398 and cap 392. For example, end 398 can be coupled to any one of a first body section 12 or 22 or a second body section 16 or 26 (See FIGS. 1A-1C) of an instrument such as a pen or pencil.

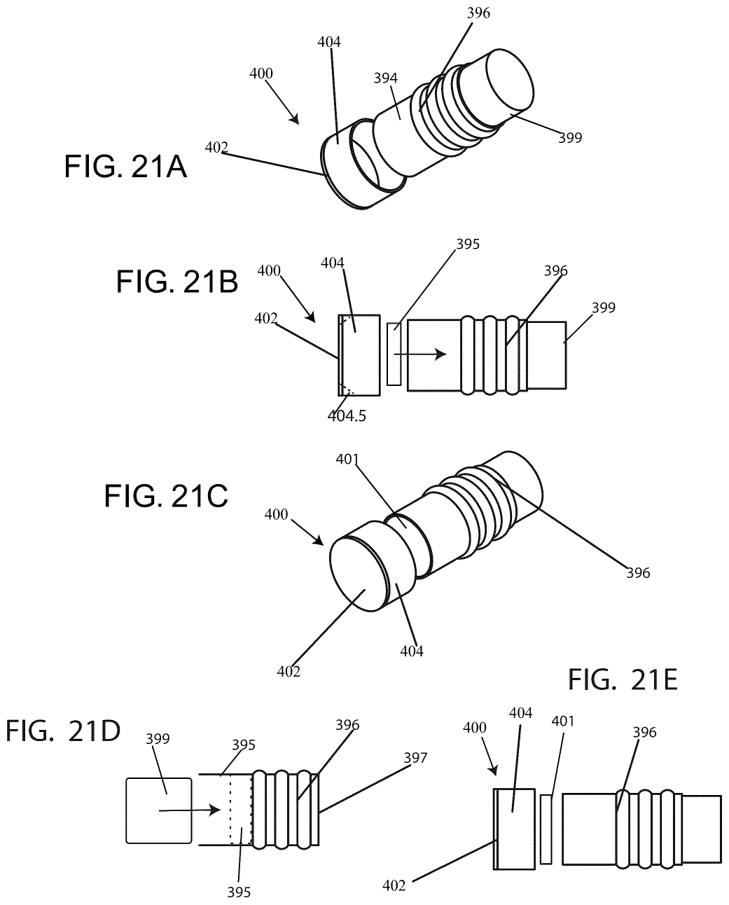

FIG. 21A shows a side perspective view of another embodiment which shows ferrule 396 having end 394 which is configured to be coupled to a cap 400 having a side body portion 404 and an end cap portion 402. At an opposite end, there is an eraser 399 or corresponding body section which is configured to be coupled to ferrule body 396. These components are also shown in FIGS. 21B and 21C. For example, in FIG. 21C there is shown magnet 401 which can be covered by cap 400 wherein end piece 402 is configured to allow for a magnetic connection to an adjacent magnet or an adjacent cap which covers a magnet such as magnet 395. Thus, these caps can be thin enough to allow magnets adjacent to the covered magnet to engage magnetically with a magnet such as magnet 401. The edges of these caps 400 can be of any suitable shape such as beveled, frusto-conical, rounded or any other suitable shape as shown by the line 404.5.

As shown in FIG. 21D there is a ferrule 396 which has a closed end 397 and which is configured to house a magnet 395 which can be dropped therein. Magnet 395 can be disposed inside of ferrule body 396 and then the eraser 399 is dropped into the ferrule and then secured to ferrule so that it locks the magnet 395 therein.

FIG. 21E is a side perspective view of the embodiment of FIG. 21A which shows cap 400 which has end piece 402 and body section 404 which is then configured to cover magnet 401 which can be embedded into an indented section in ferrule 396.

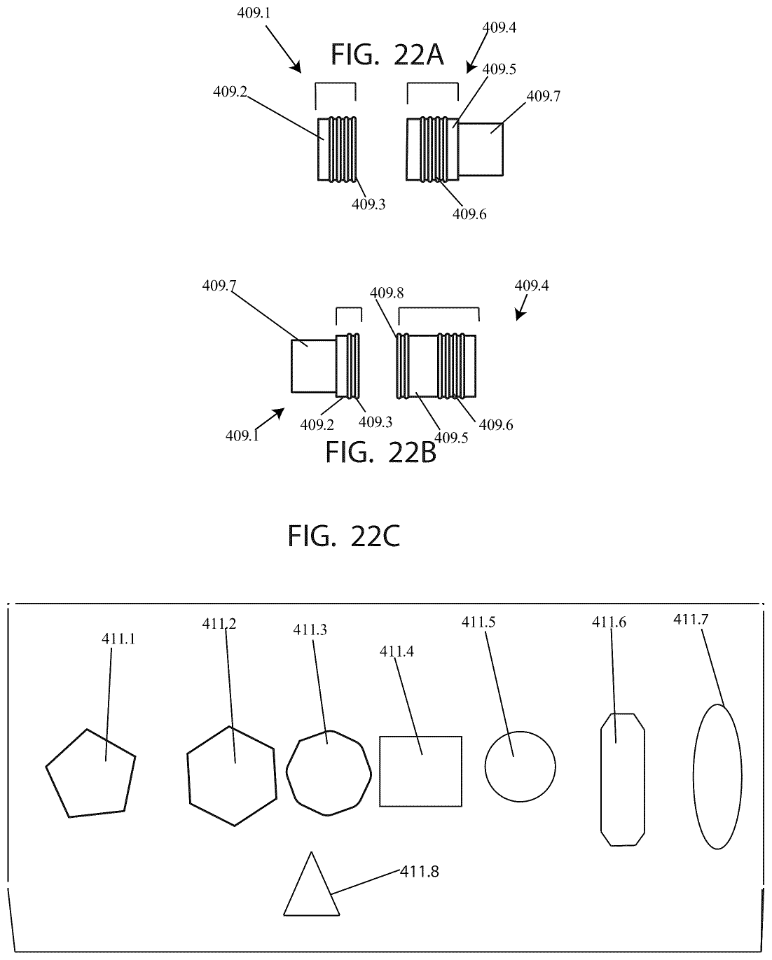

FIG. 22A is a side view of an embodiment which shows a split ferrule comprising a first ferrule section 409.1 and a second ferrule section 409.4. The split of the ferrule shows that approximately 60% of the length of the total ferrule is in ferrule section 409.4 and 40% of the length of the ferrule is in section 409.1. Ferrule section 409.1 has a first part 409.2, and a second part 409.3 having ridges. Ferrule section 409.4 has a first section 409.5 and a second part 409.6 which has ridges. There is also a body section 409.7 which can be in the form of an eraser or a body section of an adjacent pen or pencil. Ferrule section 409.2 can be coupled to an adjacent body section as well.

FIG. 22B is a side view of another embodiment which shows a split ferrule having a first ferrule section 409.1 and a second ferrule section 409.4. First section 409.1 has a first part 409.2 and a second part 409.3 Second section 409.4 includes ridge section 409.8 spacer section 409.5 and ridged section 409.6. The length of section 409.1 is shown to be shorter than the length of section 409.4 on a 1:4 basis such that length of section 409.1 is approximately 20% of the total length of the combined length of the two sections and length 409.4 is approximately 80 percent of the combined length of the two sections 409.1 and 409.4. While the 1:4 size ratio between the ferrules is shown, other ratios can be used such as 1:1, 1:2, 1:3, 1:5, 1:6 or any other suitable ratio.

FIG. 22C is a top view of the magnets that can be housed in any one of the ferrule sections 409.1 and 409.4 or any of the other ferrule sections or body sections of a pen, pencil or other object. For example, there is shown a first magnet 411.1 having a pentagonal shape, a second magnet 411.2 having a hexagonal shape, another magnet 411.3 having an octagonal shape, another magnet 411.4 having a square shape, another magnet 411.5 having a circular shape, and another magnet 411.6 having an elongated hexagonal shape (similar to a carpenter's pencil) or another magnet having an oval shape 411.7 or triangle 411.8. For each of these shapes, the corresponding cover can have these shapes as well such as cover 412 in FIG. 23A, or 23B.

FIG. 23A is a side bottom perspective view of another embodiment 410 which discloses a body section 416, a magnet 414 and a cover 412. Cover 412 is a one-piece cover which is configured to cover magnet 414. The cover 412 has stippling 411 which can comprise indents and detents to provide an optionally roughened surface on the outside of the cover 412. Thus, when the objects are rotating around each other the stippling 411 can provide heightened interaction including additional noise relating to the sound of the components rotating vs. each other.

FIG. 23B is a side view of a similar embodiment to embodiment of FIG. 23A. This view shows embodiment 410 which discloses cap or cover 412 which covers magnet 414 when magnet 414 is embedded into body section 416, such as in recess 418 (FIG. 23C) in body section 416. Cap 412 has at least one groove 413 which is disposed on the outside surface of cap or cover 412. Groove 413 provides heightened interaction between the objects as they are rotating vs. each other.

FIG. 23C is a top side perspective view of the embodiment of FIG. 23A, this view shows recess 418 which is configured to receive magnet 414 while cover 412 covers magnet 414 and is then secured to body section 416. Cover 412 can be secured to body section 416 either via crimping, threads, glue or any other suitable securing means.

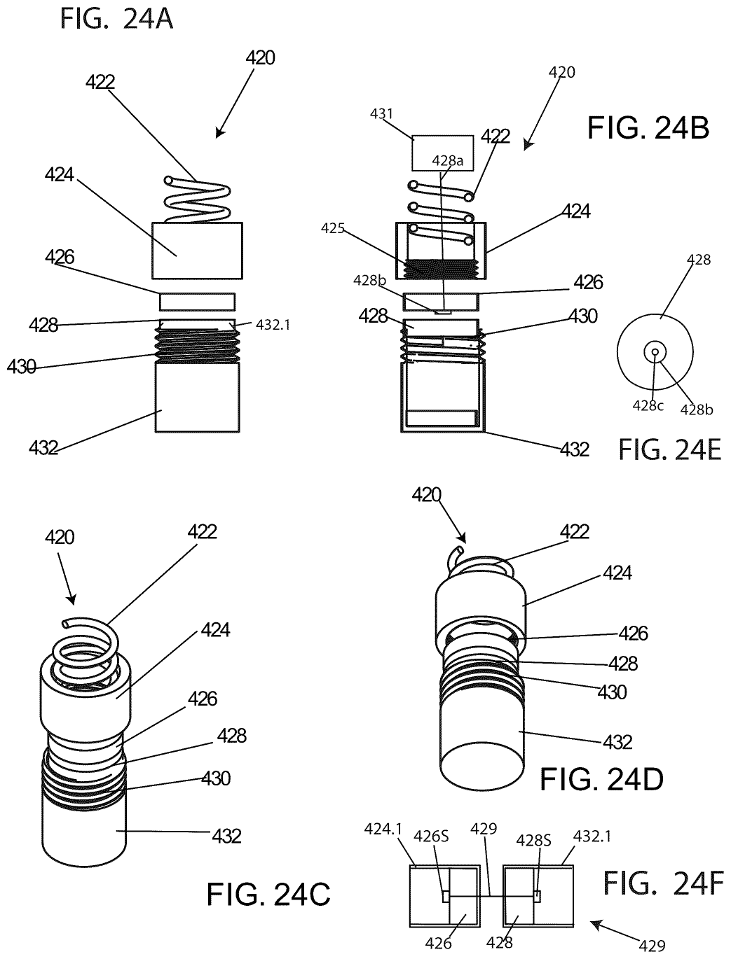

FIG. 24A is a side exploded view of a spring-loaded device 420 which is essentially a spring positioned inside of body 424. A magnet 426 is positioned adjacent to body 424. This magnet 426 is biased by spring 422. There is also a housing body 432, wherein this housing 432 has threading 430 wherein a magnet 428 is set in body 432.

FIG. 24B is a side open exploded view of the embodiment of FIG. 24A. In this view there is embodiment 420 which shows spring 422, and body section 424. Body section 424 has a plurality of threads 425 disposed inside of body section 424. Magnet 426 is shown adjacent to body section 424 and is biased by spring 422. There is also body 432, which is configured to house fixed magnet 428. In addition, there can also be a string or cable 428a and a stopper 428b. String or cable 428a is configured to extend from base 431 coupled to and disposed in body 424 through the spring 422 through magnet 426 and to end of magnet 426 to stopper 428b. Thus, magnet 426 is spring loaded within body 424.

FIG. 24C is a side exploded cut away perspective view of embodiment 420 which shows spring 422 positioned inside of body 424. Body 424 can be in the form of a body section of a pen, pencil or another type of writing instrument. There is also shown a magnet 426, an opposite magnet 428 a body section 432 having threads 430. Body section 432 can be a body section for a writing instrument or a pencil as well. The threads 430 are configured to mesh with threads 425 (see FIG. 24B). FIG. 24D is a bottom perspective view of embodiment 420 which shows springs 422, body section 424, magnets 426 and 428, threads 430 and body section 432. In at least one embodiment magnet 428 is crimped into body sections 432 in a region of threads 430. Thus, the body section 424 is configured to screw down onto body section 432 via the corresponding threads 425 and 430. Thus, when these body sections are secured together the magnets are positioned inside of their respective housing. When the housings are unscrewed from each other the spring 422 spring magnet 426 out so that it extends outside of housing 424. Threads 425 and 430 form a fastener or connector for one physical connection between body section 432 and body section 424.

FIG. 24E shows an end view of an alternative design for the magnets wherein magnet 428 is shown having a center hole 428c which is configured to receive string or cable 428a. Stopper 428b is shown sitting on top of center hole 428c. When body 424 is screwed onto body 432 with threads 425 meshing with threads 430 this drives magnet 426 into spring 422 to cause magnet 426 to extend into body 424.

FIG. 24F is a side cut away view of two separate caps and magnets coupled together with an elastic band. In this view there is a cover 424.1 which is configured to house a magnet 426. There is an opposite cover 432.1 which is configured to house a magnet 428. An elastic band or connector 429 extends between the two covers 424.1 and 432.1 through holes in the covers and through corresponding holes in magnets 426 and 428 respectively. At the end of this elastic band or connector 429 are respective stoppers 426s and 428s. Thus, elastic band or connector 429 extends through each cover and through a corresponding center hole in respective magnets 426 and 428. Stoppers 426s and 428s then lock the elastic band 429 to the two separate magnets 426 and 428 at each end. Thus if there is a force pulling these covers 424.1 and 432.1 apart, the elastic band or connector 429 is configured to pull these corresponding covers and magnets back together.

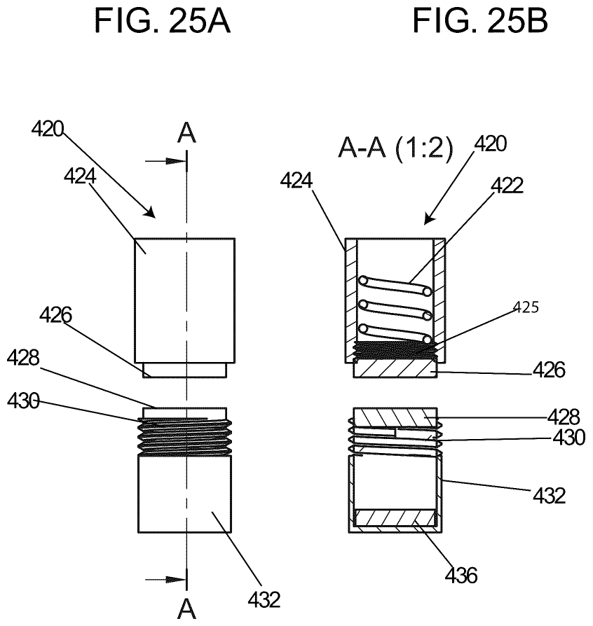

This positioning is shown in FIGS. 25A and 25B, which shows the embodiment 420 which shows body sections 424 and 432 as well as threads 430 and 425. Magnets 426 and 428 are shown attracting each other and magnet 426 is supported by spring 422.

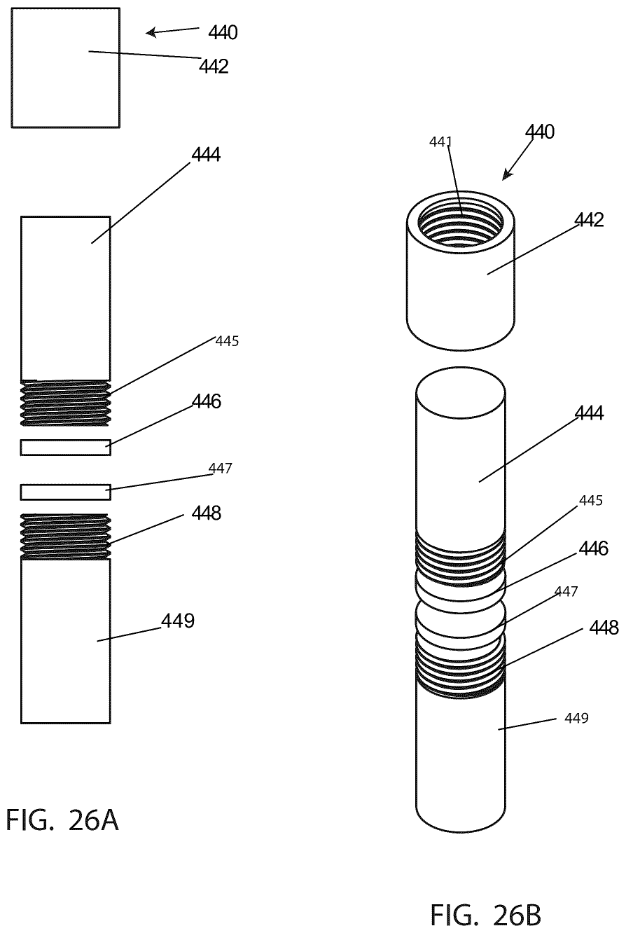

FIG. 26A and FIG. 26B show exploded views of another embodiment 440. This embodiment has bodies 444 and 449 as well as a cover housing 442 which is configured to screw down on bodies 444 and 449 to secure these two bodies together. There are also shown magnets 446 and 447 wherein magnet 446 is configured to be associated with body section 444. Magnet 447 is configured to be associated with body section 449. These magnets 446 and 447 are each configured to be substantially such as largely, or mostly housed inside of the associated bodies 444 and 449. Cover housing 442 has threads 441 which is configured to be screwed onto threads 445 and 448 to draw the bodies 444 and 449 together.

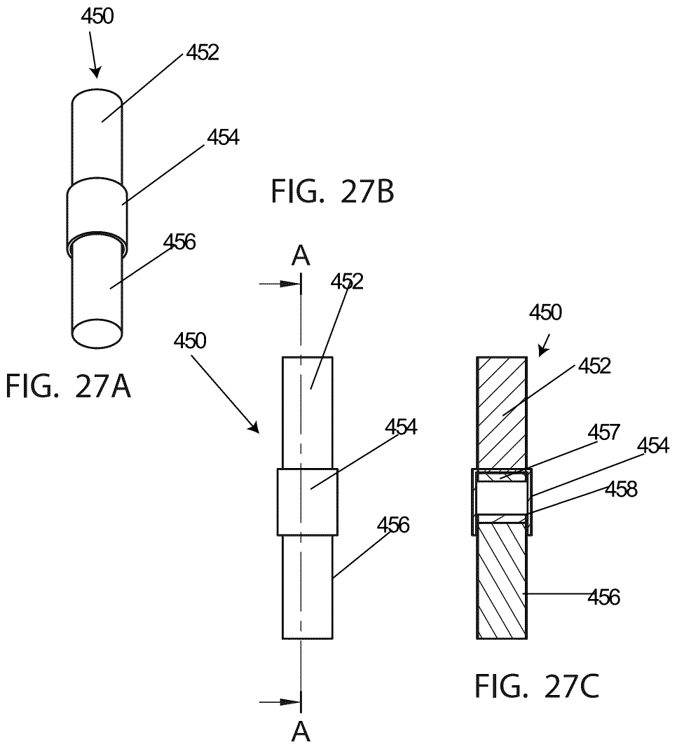

FIGS. 27A, 27B and 27C show another embodiment 450. Embodiment 450 includes a body section 452, a cover or coupling 454, and another body section 456. These body sections can be in the form of body sections for writing instruments, or other tools which can be converted into a spinner which allows for rotation of one body vs. another body via magnets 457 and 458. FIG. 27C shows the side cross-sectional view of the profile of the embodiment 450 shown in FIG. 27B. This view shows body section 452 magnet 457, magnet 458 and body section 456 which is coupled to magnet 458. Magnet 457 is coupled to body section 452. The cover 454 is configured as a slidable cover slidable on body sections 452 and 456 so that when this cover is slid axially it allows for the separation of the two body sections 452 and 456 so that the magnets can be positioned adjacent to each other to allow for the angled interaction between the magnets so that the two different body sections 452 and 456 which may be in the form of body sections of a pen, pencil or other instrument

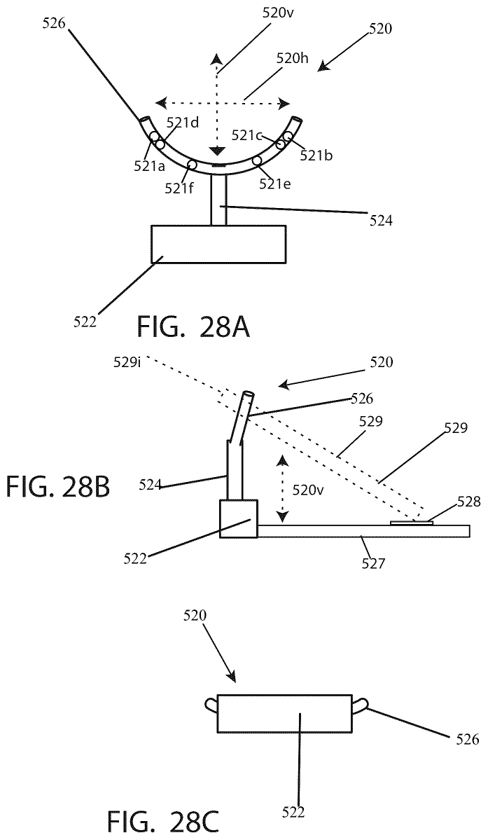

FIG. 28A is a front view of a stand. This stand 520 is configured to support an instrument such as a writing instrument such as the embodiments shown in FIG. 15A or FIGS. 1A, 1B or 1C above a surface along a vertical axis 520v and a horizontal axis 520h. For example, stand 520 includes a base 522, a support shaft 524 and a substantially magnetic support 526. The substantially magnetic support 526 can be arc shaped or semi-circular shaped and be either entirely magnetic, or at least partially magnetic to support an instrument or writing implement such as implement 350 (See FIG. 15A) above a surface. In this view either the entire support 526 can be magnetic or a portion of the entire support such as sections 521a and 521b, 521c, 521d, 521e, and 521f are magnetic. In at least one embodiment the magnets 521a, 521b, 521c, 521d are of the same polarity so that it can provide a single consistent magnetic repelling force on magnets of a writing implement spaced apart from the body 526.

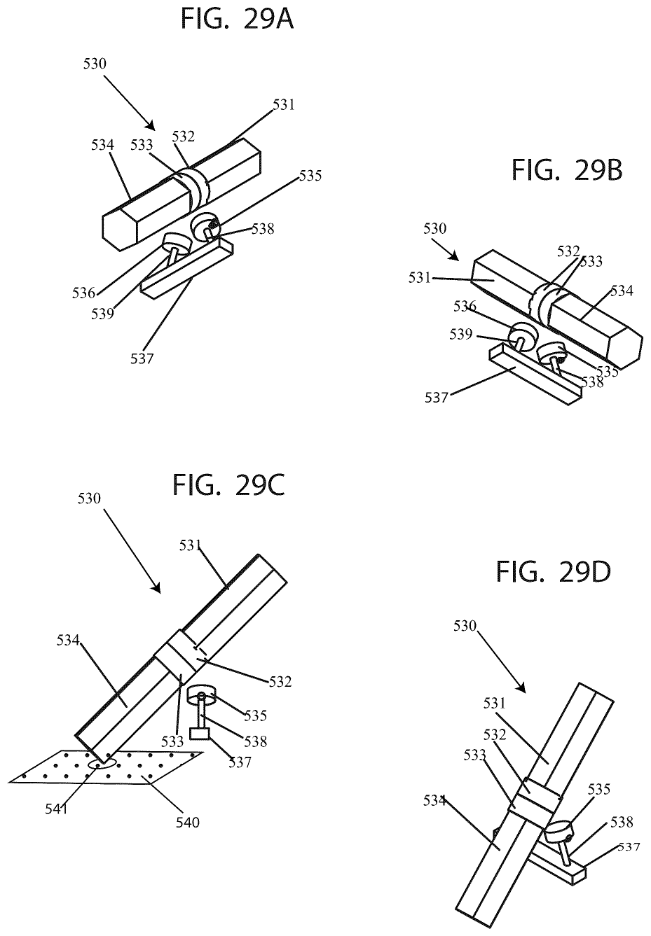

FIG. 28B is a side view of a stand which shows base 522, support shaft 524 and substantially magnetic support 526. FIG. 28C is a bottom view of a stand 520 showing stand portion 522 and support 526. This stand also includes an extension portion 527 which includes a stopper 528 which can be in the form of ridges or a roughened portion to receive a body or instrument 529 such as a pen, a pencil or other supported object which has magnets such as that shown in FIGS. 29A-29D. Thus, in this view one end of the body 529 is supported in an angled manner both horizontally and vertically along axis 529i above a horizontal surface as shown by vertical axis 520v.

FIG. 29A is a bottom-side perspective view of a stand with an instrument. This view shows the embodiment 530 wherein there is a first body section 531, a second body section 534, magnets 532 and 533 for coupling the two body sections 531 and 534 together respectively. This instrument is then supported by a plurality of magnets 535 and 536 which are of the same polarity and are each supported by support shafts arms or extensions 538 and 539 respectively over a base 537. The magnets are angled such that they provide opposing magnetic forces for supporting the instrument over the magnets both offset vertically as well as offset horizontally by the angled magnets providing both a horizontal and vertical support component. FIG. 29B also shows a bottom side perspective view of these components while

FIG. 29C shows a side view showing magnets 532 and 533 coupled together holding body sections 531 and 534 together above magnets such as magnet 535 which is supported by a shaft 538 above stand 537. This view also includes a support or stopper 541 which can be formed as abrasions on a sheet 540. The position of the stopper or sheet 540 is set at a predetermined distance to support the magnetic end of the writing implement above the magnets 535 and 536 of the stand.

FIG. 29D is a top side perspective view of the stand of FIG. 29A showing these very same components, showing body sections 531, and 534, magnets 532 and 533, and magnet 535 coupled to stand 537 via shaft 538.

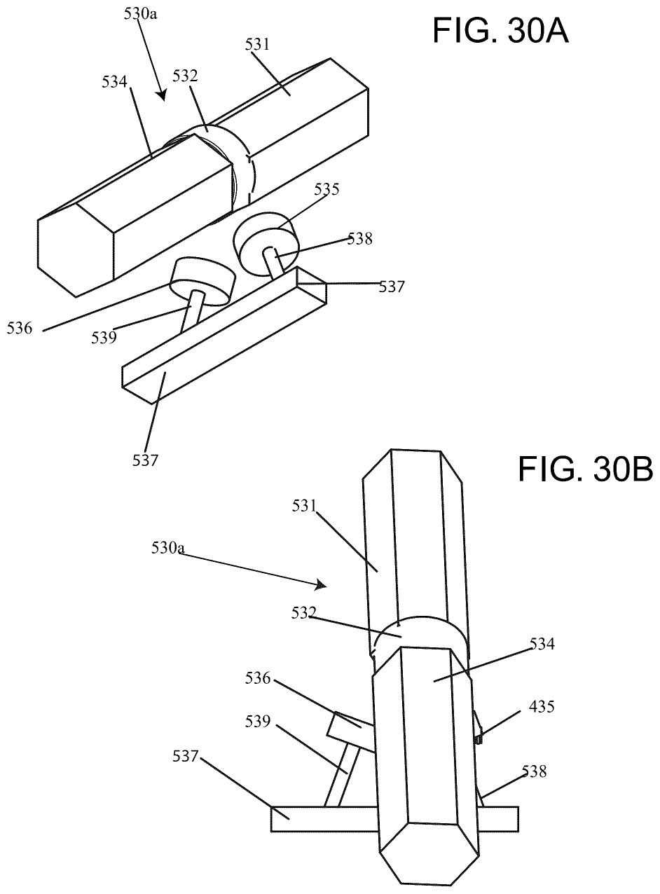

FIG. 30A shows a bottom perspective view of another embodiment 530A which shows body section 531 coupled to body section 534 via magnet 532. Stand 537 is shown which have shafts 538 and 539 supporting magnets 535 and 536. Magnets 535 and 536 are positioned to provide both vertical and lateral support for the instrument being supported. FIG. 30B shows these components as well which shows stand 537 supporting shafts 538 and 539 which support magnets 535 and 536 which then provide both vertical and horizontal for magnet 532. Coupled to either side of magnet 532 are body sections 531 and 534 (See FIG. 30B). Body sections 531 and 534 can be coupled to magnet 532 via their own embedded magnets or via standard fastening such as via a physical fastener such as a rivet, screw or bolt or via an adhesive or a separate cap or ferrule connected to embodiment.

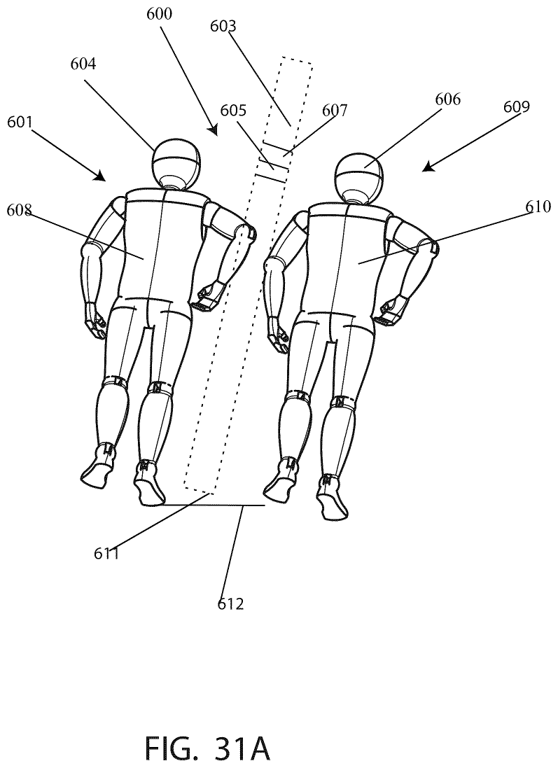

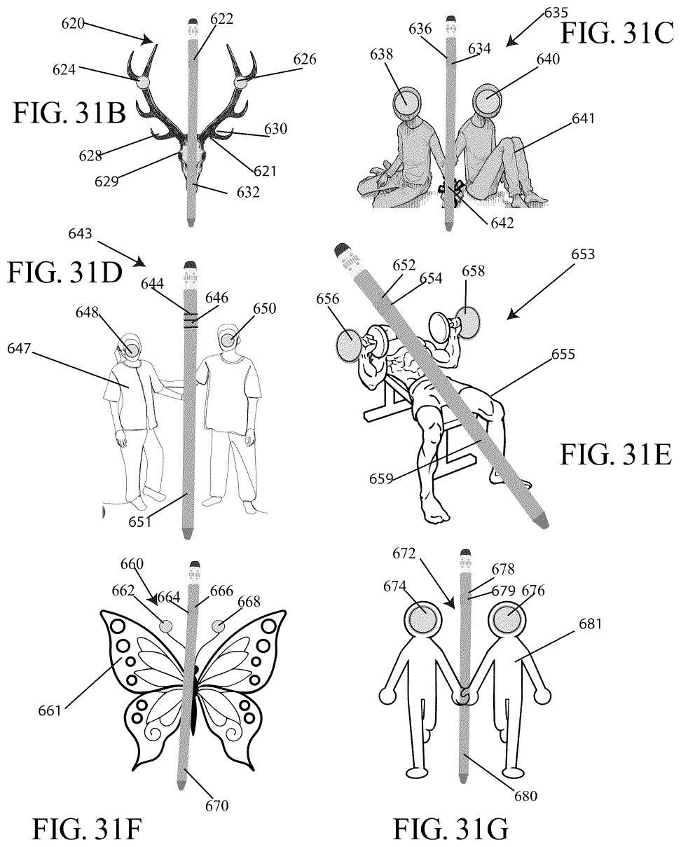

FIG. 31A is a prone view of another embodiment of a stand 600 which includes two separate artistic renderings of two different bodies or people 601 and 609 in the prone position with a device 603 having magnets 605 and 607 positioned in between. This device 603 can be in the form of a pencil, pen, fidget spinner or other type of device having magnets. Body 601 has a magnet 604 embedded in a head section. Body 609 has a magnet 606 embedded in the head section. These bodies are configured to support the device 603 above the heads via the magnetic interaction between magnets 604 and 606 and the magnets 605 and 607 wherein these magnets have both a vertical and horizontal support component such as described above. These bodies or people 601 and 609 have respective body sections 608 and 610 as well as a footing stopper 612 for supporting a base end 611 of the device 603. This base end functions similar to stopper 528 described above. The device or instrument 603 is then supported in a position that has both a horizontal and vertical orientation and magnetic support in both a horizontal and vertical manner, when bodies 608 and 610 are placed on a horizontal surface.

FIG. 31B is a view of another embodiment 620 which shows a pencil 632 which includes magnets 622. There is a stand 621 which includes antlers 628 and 630 which have magnets 624 and 626 respectively. The magnets 624 and 626 are configured to support the magnets 622 on pencil 632 above a surface and between the two magnets 624 and 626 (horizontally and vertically supporting) the magnets.

FIG. 31C is another view of another embodiment 635 which includes a stand 641 representing two different people having magnets 638 and 640 wherein these magnets are configured to support magnets 636 and 634 magnetically above a surface in both a horizontal and vertical manner thereby supporting pencil 642. Thus for all of the embodiments of FIGS. 28A-31G the magnetic support from the stand magnetically supports an instrument or device above the stand to provide the impression of the instrument floating freely above the stand.

FIG. 31D is a view of another embodiment 643 comprising two different people having magnets 648 and 650 coupled to a stand 647 positioned in the heads of these people in the stand. The magnets 644 and 646 are positioned in pencil 651 whereby magnets 648 and 650 are configured to support magnets 644 and 646 above a surface in both a horizontal and vertical manner.

FIG. 31E is a view of another embodiment 653 which shows a pencil 659 having magnets 652 and 654. These magnets are supported by magnets 656 and 658 which are presented as dumbbells for a weightlifter in a stand 655. Magnets 658 and 656 are used to support magnets 652 and 654 in both a horizontal and vertical manner.

FIG. 31F is a view of another embodiment 660 which is a view of a butterfly which has tentacles forming a stand 661 which each support magnets 662 and 668. Pencil 670 includes magnets 664 and 666 disposed therein. These magnets 664 and 666 are then supported over magnets 662 and 668 in both a horizontal and vertical manner.

FIG. 31G is a view of another embodiment 672 which shows a pencil 680 having magnets 678 and 679 disposed therein. There is a stand 681 which shows two people which have their heads shown as magnets 674 and 676. Magnets 674 and 676 are configured to support magnets 678 and 679 in both a horizontal and vertical manner above the stand.

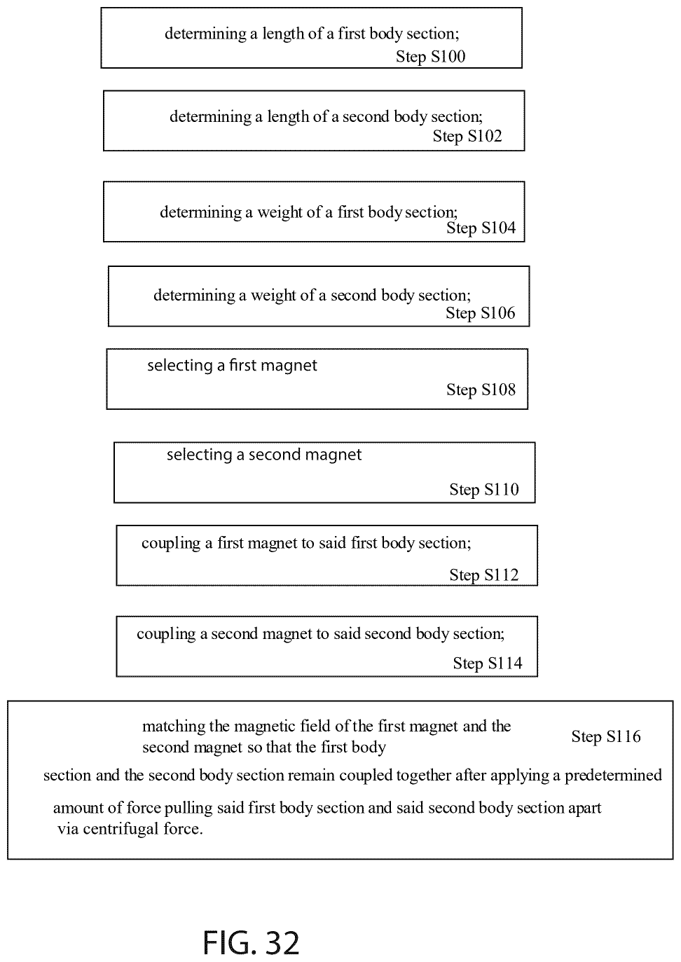

FIG. 32 is a flow chart indicating the process for creating any one of the devices shown in FIGS. 1-30B. For example, the process starts in step 100 wherein it involves determining a length of a first body section. Next, in step S102 the use can determine a length of a second body section. Next, in step S104 the user can determine the weight of the first body section by determining the mass of the first body section (density, and volume). Alternatively, the user can simply weigh the first body section. Next, in step S106 the user can determine the weight of the second body section by determining either the mass of the second body section or weighing the second body section.

Next, in step S108 the user can select a first magnet such as magnets 14, 24. Next, the user in step S110 can select a second magnet such as magnets 18 and 28.

Next, in step S112, the user can couple a first magnet to the first body section such as couple a magnet 14 to body section 12 or magnet 24 to body section 22. Next, in step S114 the user can couple the second magnet to the second body section such as magnet 18 to body section 16. The coupling of the magnets to the body section can occur by fastening these magnets to the corresponding body sections such as through a screw, nail, rivet, glue, epoxy adhesive, clasp, or any other suitable means like a separate cap cover or ferrule connected to the embodiment.

Next in step S116 the user matches the magnetic field of the first magnet such as any one of magnets 14, 24 to the magnetic field of the second magnet such as any one of magnet 18, 28, so that the first body section such as body sections 12, 22 and the second body section such as any one of body sections 16 and 26 remain coupled together after applying a predetermined amount of force pulling the first body section 12, 22 away from the second body section 16, 26 via the user rotating the first body section 12, 22 around the second body section 16, 26 and thereby pulling these body sections apart via the centrifugal force.

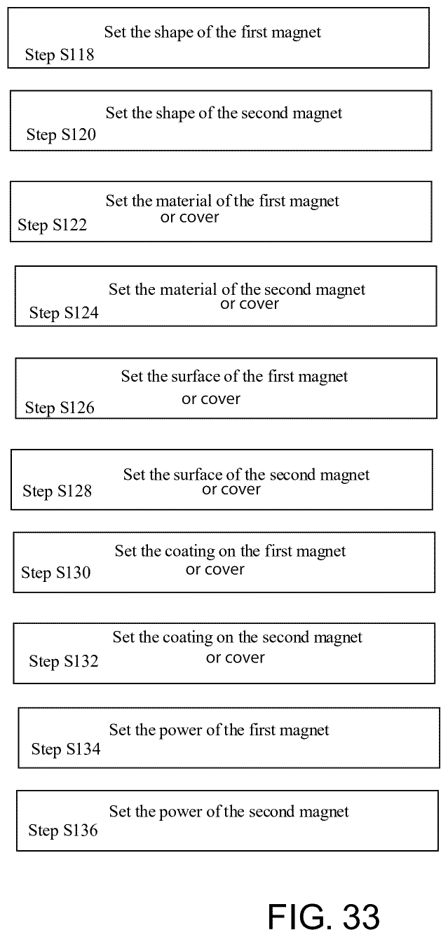

FIG. 33 is a view of the steps for selecting a magnet or cover such as that shown in steps S108 and S110. For example, this process starts in step S118 wherein the user can set the shape of the first magnet. Next, in step S120 the user can set the shape of the second magnet. Next in step S122 the user can set the material of the first magnet or cover. Next, in step S124 the user can set the material of the second magnet or cover. The cover material can be any suitable protective material like metal plastic or carbon fiber. Next, in step S126 the user can set the surface of the first magnet or cover. The surface of this magnet can be any suitable surface such as that shown in FIGS. 5A-5F and can include grooves, bevels, stipple, such as protrusions and indents, smooth, or any other type of suitable surface or protected covered surface. Next, in step S128 the user can set the surface of the second magnet in a manner, same or similar to step S126. Next, in step S130 the user can set the coating of the first magnet. This coating can also include coatings, paintings, or coverings of the magnets as well to improve wear, adjust the magnetic field or for simply cosmetic reasons. Furthermore, in step S132 the user can set the coating on the second magnet or cover in a manner similar to step S130. Next, in step S134 the manufacturer can set the power of the first magnet and in step S136 the manufacturer can set the power of the second magnet. The power or magnetic field of each of these magnets is influenced by the material of the magnet, the magnetic charging of the magnet, the coating(s) on the magnet as well the surface interaction of each of these magnets as they intersect with each other. The cover can be of any suitable material and is a different component from the magnet. This can include any suitable type of metal, plastic, composite, ceramic, or any other suitable material.

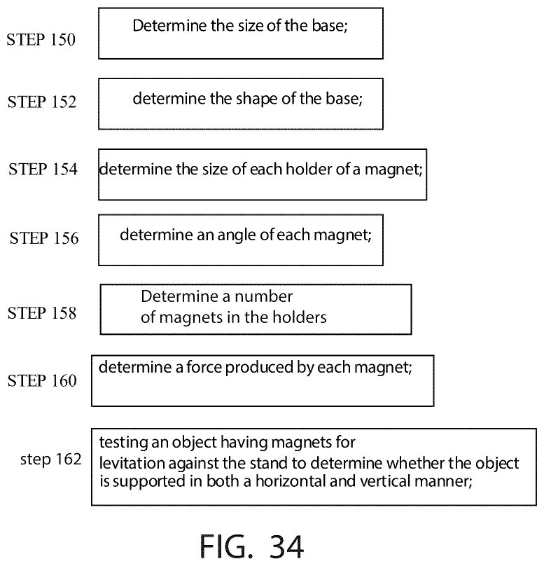

FIG. 34 is a view of a flow chart for the process for making the stand. The stand can be created by first determining the size and or shape of a base in step 150 such as base or stand 537. Other bases can include base or stand 641, base or stand 647, base or stand 655, base or stand 661, or base or stand 681. Next in step 152 the shape of the base or stand can be selected. Next, in step 154 the size of each holder of the magnet can be selected. See for example the antlers 628 and 630 in FIG. 31B. Next, in step 156 the angle of orientation of each magnet such as magnets 521a, 521b, 521c, 521d, 521e, and 521f can be selected. Next, in step 158 a number of each magnet can be selected such as any one of magnets 521a-521f disclosed above. Next, in step 160 the force produced by each magnet is selected to support an object having magnets such as pencil 642 having magnets 634 and 636 above magnets 638 and 640 above the associated stand 641. Next, in step 162 the object such as object 642 can be tested so that it is supported both vertically and horizontally by the magnetic force of the magnets above the stand 641. While the steps of FIGS. 31-34 are shown in order, the steps can be performed in any suitable way or order so as to produce the embodiments of FIGS. 1A-31G.

Thus, by particularly selecting different magnets and different bodies to work together the user can create a device suitable to allow a first body to spin around or rotate around a second body to provide entertainment or enjoyment or even relief to the user while they use the device.

Thus, there is created a stand that can provide support for an instrument such as a writing implement to provide both vertical and horizontal support for the writing implement above a surface such as a weightlifter, or a butterfly or two people or a curved stand or and stand surface the creative imagination can create.

Accordingly, while at least one embodiment of the present invention have been shown and described, it is to be understood that many changes and modifications may be made thereunto without departing from the spirit and scope of the invention as defined in the appended claims.

What is claimed is:

1. A device having a magnetic connection comprising:
a first body section;
a second body section;
at least one first magnet having coupled to the first body section;
at least one second magnet coupled to the second body section;
wherein the at least one first magnet is polarized to have a first magnetic field; and
wherein the at least one second magnet is polarized to have a second magnetic field that is configured to attract said at least one first magnet and wherein said at least one first magnet and said at least one second magnet have a magnetic field configured to keep said at least one first magnet in contact with said at least one second magnet while said at least one first magnet is spinning or rotating around said at least one second magnet.

2. The device as in claim 1, wherein at least one of said first magnet and said second magnet has an edge that is shaped as either rounded, beveled, square, or frusto-conical.

3. The device as in claim 1, wherein at least one of said at least one first magnet and said at least one second magnet is coupled to a corresponding body section via a fastener or a separate cover to hold the magnet and fasten the magnet to a corresponding body section.

4. The device as in claim 3, wherein said fastener is at least one of an adhesive, glue, stud, clasp, clamp, crimp, screw, rivet or friction fit.

5. The device as in claim 1, wherein at least one of said first magnet and said second magnet has a cross-sectional shape of a circle, oval, a square, a hexagon, an octagon, triangle, or any other multi-sided shape having at least three sides.

6. The device as in claim 5, further comprising at least one connector wherein said at least one connector comprises at least one of an elastic string, a rope, a line, an elastic band, or an elastic cable and wherein said at least one connector is configured to couple said first body section to said second body section.

7. The device as in claim 1, further comprising at least one cover, said at least one cover for covering at least one of said at least one first magnet and said second magnet, and wherein said cover is for coupling at least one of said first magnet or said second magnet to at least one of said first body section and said second body section.

8. The device as in claim 7, wherein said at least one cover has an edge that is shaped as either rounded, beveled, square, or frusto-conical.

9. The device as in claim 6, further comprising at least one rotatable cylinder, wherein said at least one rotatable cylinder is coupled to at least one of said first body section and said second body section, and wherein said at least one connector is coupled to said rotatable cylinder at one end and to at least one of said first body section and said second body section at a second end.

10. The device as in claim 1, wherein said first magnet and said second magnet comprise a body section and wherein at least one of said first magnet and said second magnet has threads on said body section.

11. The device as in claim 7, wherein said at least one cover comprises a first cover and a second cover, said first cover for covering said first magnet and said second cover covering said second magnet, wherein at least one cover comprises stippling, indents or protrusions or grooves to increase interaction between said first cover and said second cover to increase vibration and noise created between movement of said first cover and said second cover.

12. The device as in claim 7, wherein said at least one cover has an edge that is shaped as either rounded, beveled, square, or frusto-conical and wherein said at least one cover has a cross-sectional shape of a circle, oval, a square, a hexagon, an octagon, triangle, or any other multi-sided shape having at least three sides.

13. The device as in claim 1, wherein said first body section comprises at least one of a pencil or a pen having a writable end at a first end and a second opposite end coupled by said first magnet and said second magnet.

14. The device as in claim 1, wherein at least one of said first body section and said second body section have at least one of a reflective surface or a light to create visual effects when spinning.

15. A process for creating a device with magnets comprising the following steps:
a) determining a length of a first body section;
b) determining a length of a second body section;
c) determining a weight of a first body section;
d) determining a weight of a second body section;
e) coupling a first magnet to said first body section;
f) coupling a second magnet to said second body section;
g) setting a magnetic field of at least one first magnet;
h) setting a magnet field of at least one second magnet; and
i) matching the magnetic field of the first magnet and the second magnet so that the first body section and the second body section remain coupled together after applying a predetermined amount of spinning force pulling said first body section and said second body section apart.

16. The process as in claim 15, further comprising the step of
a) determining a size of a first cap or ferrule which is configured to couple said at least first magnet to said first body section;
b) determining a size of a second cap or ferrule which is configured to couple at least one second magnet to said second body section; and
c) determining a size ratio of said first cap or ferrule relative to said second cap or ferrule.

17. The process as in claim 16, wherein the size ratio of said first body section to said second body section is on a size ratio of any one of 1:1, 1:2, 1:3, 1:4, 1:5, or 1:6.

18. The process as in claim 16, wherein the size ratio of said first cap or ferrule to said second cap or ferrule is any one of 1:1, 1:2, 1:3, 1:4, 1:5, or 1:6.

19. The process as in claim 15 further comprising the step of: coupling at least one magnet of said at least first and second magnets to at least one of said at least one first and second body section so that said at least one magnet is at least partially disposed in one of said first body section and said second body section.

20. The process as in claim 16, wherein each of said cap or ferrule have a rounded or beveled edge, a top face, and a side face, and wherein each of said cap or ferrule are configured to spin around at least one of said rounded or beveled edge, said top face, or said side face of an adjacent cap or ferrule.

21. The process as in claim 19, wherein said step of selecting said first magnet and said second magnet includes selecting said first magnet and said second magnet to allow said first body section and said first magnet to spin around said second body section and said second magnet while said first magnet is coupled to said second magnet.

22. A stand configured to support bodies in a magnetic manner said stand comprising:
a base;
at least one magnet coupled to the base; and
wherein said at least one magnet is configured to support an object above a surface in both a horizontal and vertical manner.

23. The stand as in claim 22, wherein said at least one magnet comprises at least one first magnet and at least one second magnet.

24. The stand as in claim 23, further comprising at least a first extension and at least a second extension wherein said first extension is configured to support said at least one first magnet above said base, and said second extension is configured to support said at least one second magnet above said base.

25. The stand as in claim 23, further comprising at least one stopper, wherein said at least one stopper is configured to stop a movement of at least one object resting above said at least one first magnet and said at least one second magnet.

26. The stand as in claim 22, further comprising at least one writing implement having at least one magnet, wherein said at least one writing implement has a writing tip, wherein said at least one writing implement is configured to rest above said stand at an angle off of horizontal and vertical but supported in both a horizontal and vertical manner by said at least one magnet of said stand wherein said at least one magnet of said writing implement is disposed in a region of said writing implement distal from said writing tip.

27. The stand as in claim 26, wherein the stand is configured to magnetically support said at least one writing implement in a region of said writing implement that is distal from said writing tip of said at least one writing implement.

28. A process for making a stand as claimed in claim 22, wherein the process comprises the following steps:
determining a size of said base;
determining a shape of said base;
determining a size of each magnet of said first magnet and said second magnet;
determining an angle of each magnet of said first magnet and said second magnet; and
determining a number of magnets in said stand such that said magnets including said first magnet and said second magnet are configured to support an object having a magnet above the stand in both a horizontal and vertical manner.

29. The device as in claim 1, wherein at least one magnet of said first magnet and said second magnet comprises a surface having stippling, indents or protrusions or grooves to increase interaction between said first cover and said second cover to increase vibration and noise created between movement of said first magnet and said second magnet.

30. The device as in claim 1, further comprising at least one first cover for coupling said at least one first magnet to said first body section, at least one second cover for coupling said at least one second magnet to said second body section and at least one connector, for coupling said at least one first cover to said at least one second cover.

31. The device as in claim 1, wherein at least one of said first body section and said second body section further comprises a fastener for connecting to an adjacent body.

32. The device as in claim 1, wherein said first body section is larger than said second body section.
